(19) United States
(12) Patent Application Publication
(10) Pub. No.: US 2026/0279078 A1
(43) Pub. Date: Sep. 17, 2026

(54) TUNNEL SCENE RECOGNITION METHOD AND APPARATUS, AND DEVICE AND STORAGE MEDIUM

(71) Applicant: Tencent Technology (Shenzhen) Company Limited, Shenzhen (CN)

(72) Inventor: Guihai LI, Shenzhen (CN)

(21) Appl. No.: 19/669,781

(22) Filed: May 6, 2026

Related U.S. Application Data
(63) Continuation of application No. PCT/CN2024/134621, filed on Nov. 26, 2024.

(30) Foreign Application Priority Data
Jan. 8, 2024 (CN) 202410023074.0

(51) Int. Cl. G06V 20/64; G06T 7/33; G06T 15/06; G06T 19/00

(52) U.S. Cl. CPC G06V 20/64; G06T 7/344; G06T 15/06; G06T 19/00

(57) ABSTRACT

A tunnel scene recognition method is performed by a computer device. The method includes: acquiring point cloud data corresponding to sampling path points on a motion path of a vehicle; segmenting the point cloud data into point cloud subsets along the motion path; for each point cloud subset, determining a ray cluster including rays emitting from a ray origin on the vehicle to spatial points in the point cloud subset and a center point of the ray cluster based on positions of the spatial points; determining closed-distribution characteristics of each point cloud subset based on first distances between the spatial points and the ray origin and continuous-distribution characteristics of the point cloud subset based on a second distance between the center point and the ray origin; and recognizing a motion sub-path in the motion path based on the closed-distribution characteristics and continuous-distribution characteristics of the point cloud subsets.

### CROSS-REFERENCE TO RELATED APPLICATIONS

This application is a continuation application of PCT Patent Application No. PCT/CN2024/134621, entitled “TUNNEL SCENE RECOGNITION METHOD AND APPARATUS, AND DEVICE AND STORAGE MEDIUM” filed on Nov. 26, 2024, which claims priority to Chinese Patent Application No. 2024100230740, entitled “TUNNEL SCENE RECOGNITION METHOD AND APPARATUS, AND DEVICE AND STORAGE MEDIUM” and filed on Jan. 8, 2024, all of which are incorporated herein by reference in their entirety.

### FIELD OF THE TECHNOLOGY

This application relates to the field of computer technologies, and to a tunnel scene recognition method and apparatus, and a device and a storage medium.

### BACKGROUND OF THE DISCLOSURE

As a form of a high definition map, a point cloud map may provide abundant three-dimensional information, and help a system implement precise positioning and perception. At present, before real-time positioning based on collected point cloud data and point cloud map construction, road scene recognition is performed at first on collection paths to obtain a collection path in a special road scene. After that, a map may be constructed by using an appropriate registration algorithm on the point cloud data of the collection path in the special road scene to improve the accuracy of the point cloud map.

A tunnel scene is a common special road scene. For the tunnel scene, radar mounted on a collection vehicle is affected by a tunnel structure, closeness and the like in a tunnel, so point cloud data collected in a tunnel environment is not accurate enough, and if a registration algorithm matched with the tunnel scene is not adopted for map construction, a large error of a point cloud map may be caused.

However, an existing tunnel scene recognition method has a large calculation amount, and it is difficult to accurately recognize a motion sub-path in a tunnel scene in a collection path, so that low tunnel scene recognition efficiency and accuracy may be caused.

### SUMMARY

In view of this, for the foregoing technical problems, it is necessary to provide a tunnel scene recognition method and apparatus, a computer device, a computer-readable storage medium, and a computer program product to improve the tunnel scene path recognition effect.

In a first aspect, this application provides a tunnel scene recognition method performed by a computer device. The method includes:
acquiring point cloud data corresponding to a position of a motion path of a vehicle;
segmenting the point cloud data into a plurality of point cloud subsets along different spatial positions on the motion path;
for each point cloud subset, determining a ray cluster including a plurality of rays emitting from a ray origin on the vehicle to corresponding spatial points in the point cloud subset and a center point of the ray cluster based on positions of the spatial points in the ray cluster;
determining closed-distribution characteristics of the spatial points in each point cloud subset based on first distances between the spatial points in the ray cluster and the ray origin and continuous-distribution characteristics of the spatial points in the point cloud subset based on a second distance between the center point of the ray cluster and the ray origin; and
recognizing a motion sub-path in a tunnel scene in the motion path based on the closed-distribution characteristics and the continuous-distribution characteristics of respective spatial points in the plurality of point cloud subsets.

In a second aspect, this application further provides a computer device. The computer device includes a memory and a processor, the memory has a computer program stored therein, and the processor, when executing the computer program, causing the computer device to implement operations of the tunnel scene recognition method.

In a third aspect, this application further provides a non-transitory computer-readable storage medium. The computer-readable storage medium has a computer program stored therein, and the computer program, when executed by a processor of a computer device, causing the computer device to implement the tunnel scene recognition method.

Details of one or more embodiments of this application are provided in the accompanying drawings and descriptions below. Other features, objectives, and advantages of this application will become apparent from the specification, the accompanying drawings, and the claims.

### BRIEF DESCRIPTION OF THE DRAWINGS

To illustrate technical solutions in embodiments of this application or in the conventional technology more clearly, the accompanying drawings required for describing the embodiments or the conventional technology will be briefly introduced below. The accompanying drawings in the following description are only some embodiments of this application, and a person of ordinary skill in the art may also be able to derive other drawings from these disclosed accompanying drawings without making creative efforts.

FIG. 1 is a schematic diagram of an application environment of a tunnel scene recognition method according to an embodiment.

FIG. 2 is a schematic flowchart of a tunnel scene recognition method according to an embodiment.

FIG. 3 is a schematic diagram of point cloud segmentation of point cloud data according to an embodiment.

FIG. 4 is a schematic diagram of ray clusters corresponding to point cloud subsets according to an embodiment.

FIG. 5 is a schematic diagram of single-frame point cloud data according to an embodiment.

FIG. 6 is a schematic diagram of stitched point cloud data according to an embodiment.

FIG. 7 is a schematic diagram of point cloud data according to another embodiment.

FIG. 8 is a schematic flowchart of a tunnel scene recognition method according to another embodiment.

FIG. 9 is a schematic diagram of point cloud data in a real scene according to an embodiment.

FIG. 10 is a schematic diagram of point cloud data in a real scene according to another embodiment.

FIG. 11 is a schematic diagram of point cloud data in a real scene according to another embodiment.

FIG. 12 is a schematic diagram of point cloud data in a real scene according to another embodiment.

FIG. 13 is a structural block diagram of a tunnel scene recognition apparatus according to an embodiment.

FIG. 14 is a structural block diagram of a tunnel scene recognition apparatus according to another embodiment.

FIG. 15 is an internal structure diagram of a computer device according to an embodiment.

### DESCRIPTION OF EMBODIMENTS

The technical solutions in embodiments of this application will be clearly and completely described in the following with reference to the accompanying drawings in the embodiments of this application. The described embodiments are merely some rather than all the embodiments of this application. All other embodiments obtained by a person of ordinary skill in the art based on the embodiments of this application without creative efforts shall fall within the protection scope of this application.

The tunnel scene recognition method provided by this application may be applied to the field of intelligent transportation, and specifically, may be applied to the field of automatic driving of intelligent transportation.

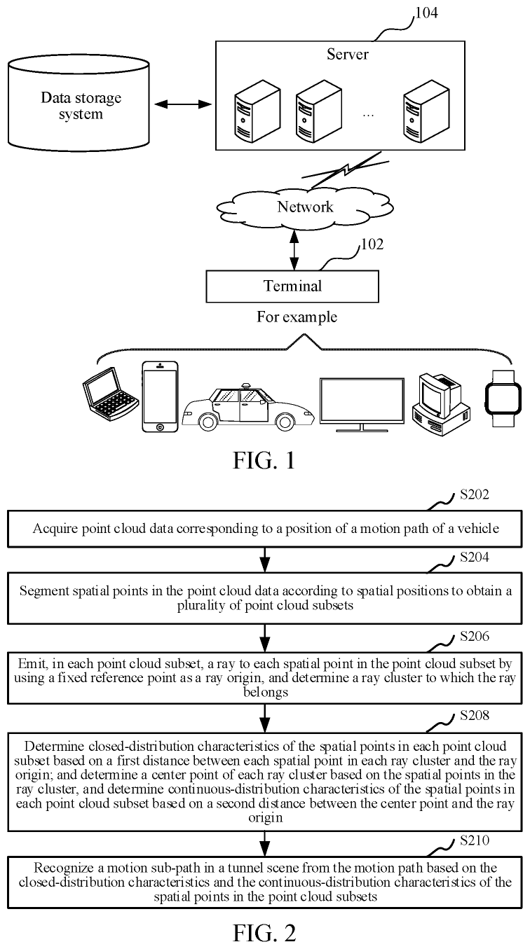

The tunnel scene recognition method according to an embodiment of this application may be applied to an application environment shown in FIG. 1. A terminal 102 communicates with a server 104 through a network. A data storage system may store data to be processed by the server 104. The data storage system may be integrated onto the server 104, and may be placed on cloud or other servers. The tunnel scene recognition method is singly executed by the terminal 102 or the server 104, or is executed by the terminal 102 and the server 104 in a cooperative manner. In some embodiments, the tunnel scene recognition method is executed by the terminal 102. The terminal 102 acquires point cloud data collected by a vehicle on a motion path; segments spatial points in the point cloud data according to spatial positions to obtain a plurality of point cloud subsets; emits, in each point cloud subset, a ray to each spatial point in the point cloud subset by using a fixed reference point as a ray origin, and determines a ray cluster to which the ray belongs; determines closed-distribution characteristics of the spatial points in each point cloud subset based on a first distance between each spatial point in each ray cluster and the ray origin; determines a center point of each ray cluster based on the spatial points in the ray cluster, and determines continuous-distribution characteristics of the spatial points in each point cloud subset based on a second distance between the center point and the ray origin; and recognizes a motion sub-path in a tunnel scene from the motion path based on the closed-distribution characteristics and the continuous-distribution characteristics of respective spatial points in the plurality of point cloud subsets.

The terminal 102 may be, but is not limited to, various desktop computers, notebook computers, smart phones, tablet computers, Internet of Things devices, and portable wearable devices. The Internet of Things device may be a smart speaker, a smart television, a smart air conditioner, a smart in-vehicle device, and the like. The portable wearable device may be a smart watch, a smart bracelet, a head-mounted device, or the like. The server 104 may be an independent physical server, or may be a server cluster or a distributed system formed by a plurality of physical servers, or may be a cloud server that provides basic cloud computing services such as cloud service, a cloud database, cloud computing, a cloud function, cloud storage, network service, cloud communication, middleware service, domain name service, security service, a content delivery network (CDN), and a big data and artificial intelligence platform. The terminal 102 and the server 104 may be connected directly or indirectly in a wired or wireless communication way, which is not limited in this application.

FIG. 2 is a schematic flowchart of a tunnel scene recognition method according to an embodiment. As shown in FIG. 2, a tunnel scene recognition method is provided. A case that the method is applied to a computer device in FIG. 1 is taken as an example for illustration. The method includes the following operations:
S202: Acquire point cloud data corresponding to a position of a motion path of a vehicle.

The vehicle may be a collection vehicle, or may be another vehicle such as an autonomous vehicle. The collection vehicle is a vehicle specifically configured to collect road environment data, and is provided with various sensor devices, such as laser radar, a camera, a global positioning system (GPS), and an inertial measurement unit (IMU), so information such as a position, an attitude, and a speed of the vehicle may be acquired in real time, and point cloud data of the road environment is acquired.

The collection vehicle travels on a road, and performs scanning and data collection on the road environment by using the plurality of sensor devices. Devices such as the laser radar and the camera may be configured to acquire point cloud data and image data of a road environment, and devices such as the GPS and the IMU may be configured to acquire position and attitude information of the vehicle, to construct a motion path of the vehicle.

Besides the collection vehicle, other vehicles may also acquire the motion path of the vehicle and the point cloud data through being provided with various sensor devices. For example, an autonomous vehicle may acquire road environment data by using sensor devices such as laser radar or a camera, to realize autonomous navigation and control of the vehicle. Compared with the collection vehicle, other vehicles need more complicated algorithm design and system integration to realize precise and stable data collection.

The motion path may be an original motion path of the vehicle, or may be a path obtained after performing sparse processing on the original motion path. The original motion path is a continuous sequence of position points passed by the vehicle in a traveling process, and a traveling route and path of the vehicle may be specifically expressed by a series of position points. The original motion path corresponds to an original point cloud data set. The original point cloud data set refers to a dataset formed by a plurality of frames of point cloud data collected based on the original motion path, includes point cloud data collected at a plurality of time points, and is configured for describing a road environment in a vehicle traveling process. Each frame of point cloud data includes three-dimensional point cloud information of the road environment acquired from a sensor at a time point corresponding to the frame of point cloud data.

The point cloud data corresponding to the position of the motion path of the vehicle may be point cloud data corresponding to a position of a path point on the motion path of the vehicle, and the point cloud data corresponding to the position of the path point may be all or part of point cloud data collected at the path point.

In a collection process of a vehicle, point cloud data frames in the original point cloud data set are not evenly distributed due to a non-constant traveling speed. For example, a problem of massive accumulation of spatial points due to jamming or parking may occur. To avoid this problem, sparse processing may be performed on the original motion path to obtain the motion path, and at the same time, sparse processing is performed on the original point cloud data set to obtain a sparsely processed point cloud data set. The path obtained after the sparse processing corresponds to the sparsely processed point cloud data set.

The sparse processing may specifically include: performing uniform sampling on the original motion path to obtain the path, and sampling the original point cloud data set according to sparse path points in the path obtained through the uniform sampling to obtain the sparsely processed point cloud data set; and may specifically include: performing equidistant sampling on the original motion path at preset distance intervals to obtain each sparse path point, and a path formed by the sparse path points is the path obtained after the sparse processing. For each sparse path point in the path obtained after the sparse processing, a frame of original point cloud data collected at a position corresponding to the sparse path point is acquired from the original point cloud data set. A set of the frame of original point cloud data corresponding to each initial path point is the sparsely processed point cloud data set. A sequential order of the sparse path points in the path obtained after the sparse processing is a frame sequence of different frames of original point cloud data in the sparsely processed point cloud data set.

For example, an original motion path is sampled at an interval of 2 m to totally obtain 60 sparse path points sequentially including a sparse path point 01, a sparse path point 02, a sparse path point 03, . . . , and a sparse path point 60. The frame sequences of the frame of original point cloud data collected at the positions corresponding to the above sparse path points in the original point cloud data set are sequentially the 1^{st} frame, the 5^{th} frame, the 8^{th} frame, the 17^{th} frame, . . . , and the 300^{th} frame. The frames of original point cloud data corresponding to these frame sequences are extracted to form a new sparsely processed point cloud data set, and the frame sequences of the frames of original point cloud data in the sparsely processed point cloud data set may be sequentially recorded as the 1^{st} frame, the 2^{nd} frame, the 3^{rd} frame, . . . , and the 60^{th} frame. The collection position of the 1^{st} frame of original point cloud data is the sparse path point 01, the collection position of the 2^{nd} frame of original point cloud data is the sparse path point 02, and by parity of reasoning, the sparsely processed point cloud data set includes a frame of original point cloud data collected at the position of each sparse path point.

Specifically, the terminal controls the vehicle to travel in a target environment, collects position and attitude data of the vehicle in the traveling process by using devices such as the GPS and the IMU mounted on the vehicle, further determines the original motion path of the vehicle based on the collected position and attitude data of the vehicle, collects point cloud data of the environment where the vehicle is located by using the laser radar mounted on the vehicle to obtain the original point cloud data set corresponding to the original motion path of the vehicle, determines the motion path of the vehicle according to the original motion path, determines the point cloud data set corresponding to the position of the motion path according to the original point cloud data set, acquires the original point cloud data corresponding to the motion path from the point cloud data set, and screens the original point cloud data corresponding to the motion path according to a preset condition to obtain the point cloud data corresponding to the motion path.

When the original motion path is directly determined to be the motion path, the point cloud data set corresponding to the motion path is the original point cloud data set. When the motion path is the path obtained after the sparse processing on the original motion path, the point cloud data set corresponding to the motion path is the sparsely processed point cloud data set.

The original point cloud data corresponding to the motion path may be all the original point cloud data in the point cloud data set, or may be the original point cloud data corresponding to the sampling path points on the motion path in the point cloud data set. The sampling path points are obtained by performing point sampling on the motion path, and the point sampling refers to selecting specific path points from the motion path.

The original point cloud data corresponding to the sampling path point in the point cloud data set may be a frame of original point cloud data collected at the position corresponding to the sampling path point. Since a single frame of original point cloud data has a small scanning range, may be unevenly distributed, may be easily interfered by noise, and is thus not accurate enough, the original point cloud data corresponding to the sampling path point may further include other frames of original point cloud data adjacent to the frame of original point cloud data in the point cloud data set. To be specific, the original point cloud data corresponding to the sampling path point in the point cloud data set may also be a frame of original point cloud data collected at the position corresponding to the sampling path point and adjacent frames of original point cloud data. The adjacent frames of original point cloud data are other frames of original point cloud data adjacent to the frame of original point cloud data collected at the position corresponding to the sampling path point in the point cloud data set. For example, if the 100^{th} frame of original point cloud data in the point cloud data set is collected at the sampling path point A, the 100^{th} frame of original point cloud data may be determined to be the original point cloud data corresponding to the sampling path point A, or the 99^{th} frame, the 100^{th} frame, and the 101^{st} frame of original point cloud data may be determined to be the original point cloud data corresponding to the sampling path point A.

In an embodiment, a process of screening, by the computer device, the original point cloud data corresponding to the motion path according to the preset condition includes: when the original point cloud data corresponding to the motion path is one frame, point cloud data meeting a height condition is selected from the frame of original point cloud data, and the point cloud data meeting the height condition is the point cloud data corresponding to the motion path.

The height condition may be specifically a preset height range. This height range may be a distance relative to the vehicle, the ground, or another reference plane. For example, a region being 2.5 m or higher from the ground may be selected as a concerned height range, to avoid the impact of pavement elements on the tunnel scene recognition effect in a subsequent processing process.

When the original point cloud data corresponding to the sampling path point is at least two frames, the at least two frames of original point cloud data may be stitched at first to obtain stitched point cloud data, and point cloud data meeting the height condition is selected from the stitched point cloud data.
S204: Segment spatial points in the point cloud data according to spatial positions to obtain a plurality of point cloud subsets. In other words, the point cloud data is segmented into a plurality of point cloud subsets along different spatial positions on the motion path.

Segmenting the spatial points in the point cloud data may be referred to as point cloud segmentation, or point cloud slicing. Point cloud segmentation refers to segmenting point cloud data formed by a large quantity of spatial points into smaller point cloud subsets according to spatial positions. The point cloud subsets are point cloud subsets divided from the point cloud data, and each point cloud subset includes spatial points in a specified region in the point cloud data. The point cloud subset may be referred to as a point cloud slicing result. The point cloud segmentation may be performed along a plane perpendicular (or approximately perpendicular) to a traveling direction of the vehicle during point cloud data collection.

Specifically, after obtaining the point cloud data corresponding to the position of the motion path, the computer device may set proper segmentation parameters for the point cloud data corresponding to the position of the motion path, and may perform point cloud segmentation on the point cloud data based on the determined segmentation parameters to obtain a plurality of point cloud subsets of the point cloud data.

The segmentation parameters refer to parameters used during point cloud segmentation on the point cloud data, and are configured for determining sizes and shapes of obtained point cloud subsets and a spatial relationship between point cloud subsets.

If the point cloud data corresponding to the position of the motion path is obtained by screening all the original point cloud data in the point cloud data set corresponding to the motion path, the proper segmentation parameters may be set, so that the obtained point cloud subset has a relatively large width, and the point cloud subsets obtained through point cloud segmentation on the point cloud data correspond to some sub-paths in the motion path. By analyzing closed-distribution characteristics and continuous-distribution characteristics of the spatial points in each point cloud subset, a scene type of the corresponding sub-path may be determined based on the closed-distribution characteristics and the continuous-distribution characteristics of the spatial points in the point cloud subset. If the point cloud data corresponding to the position of the motion path is obtained by screening the original point cloud data corresponding to sampling path points on the motion path, the point cloud subset corresponding to each sampling path point has a relatively small width, i.e., there are few spatial points in the point cloud subset, so that the analysis efficiency of the point cloud subsets of the sampling path points may be improved.

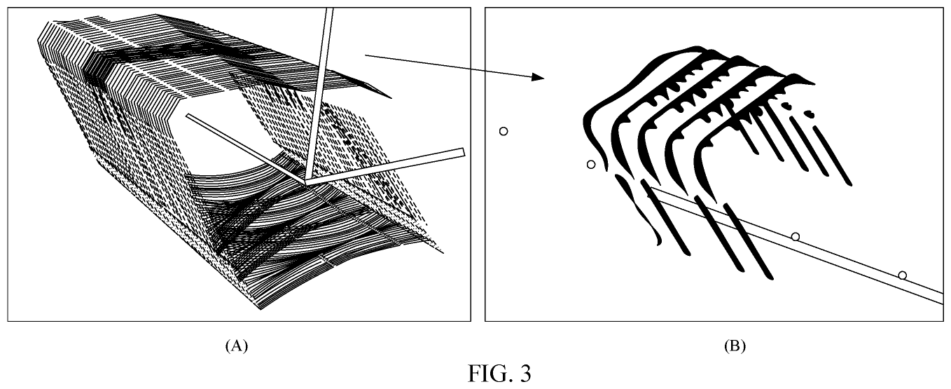

FIG. 3 is a schematic diagram of point cloud segmentation of point cloud data according to an embodiment. FIG. 3(A) shows stitched point cloud data of a plurality of frames of original point cloud data in an embodiment. After the screening according to the height condition to obtain the point cloud data, point cloud segmentation is performed on the point cloud data, and five point cloud subsets may be obtained as shown in FIG. 3(B).
S206: Emit, in each point cloud subset, a ray to each spatial point in the point cloud subset by using a fixed reference point as a ray origin, and determine a ray cluster to which the ray belongs. In other words, a ray cluster is determined for each point cloud subset, the ray cluster including a plurality of rays emitting from a ray origin on the vehicle to corresponding spatial points in the point cloud subset and a center point of the ray cluster is also determined based on positions of the spatial points in the ray cluster.

A spatial point corresponds to a ray. The ray is a straight path from a fixed reference point to the spatial point. The fixed reference point may also be referred to as a ray origin. The direction and length of the ray of each spatial point may reflect shape characteristics of the point cloud subset to which the spatial point belongs, i.e., distribution characteristics of the spatial point in the point cloud subset. The length of the ray is a distance between the spatial point and the ray origin. The ray cluster is a set of rays having similar directions. The rays having similar directions may mean that direction deviations of the rays are within a preset range, and a maximum value of a direction angle between every two rays in the ray cluster is smaller than a preset direction angle. The fixed reference point may be a point representing a position of the vehicle when the spatial point in the point cloud subset is acquired, may be specifically any one point or a center point on the vehicle, or may be a point at a center of the point cloud subset. The center may be a center of mass.

Specifically, after obtaining each point cloud subset, for any one point cloud subset, the computer device determines a ray origin and a reference coordinate axis corresponding to the point cloud subset, constructs a ray corresponding to each spatial point in the point cloud subset based on the ray origin, constructs a coordinate system according to the ray origin, selects the reference coordinate axis from the coordinate system, and determines a ray cluster to which each ray belongs according to a position relationship between the ray and the reference coordinate axis.

In an embodiment, S206 specifically includes the following operations: in each point cloud subset, the fixed reference point is used as the ray origin, and the reference coordinate axis is determined; the ray is emitted from the ray origin to each spatial point in the point cloud subset; an included angle between each ray and the reference coordinate axis is determined; and the ray cluster to which each ray belongs is determined based on the included angle.

The ray origin and the reference coordinate axis may be selected according to an actual requirement. The specific position of the ray origin may be a position of the laser radar when the point cloud subset is collected. The position of the laser radar and the position of the spatial point in the point cloud subset are discussed under the condition of being in the same coordinate system. If the coordinate systems of the two are different, corresponding coordinate transformation is needed to make the coordinate systems of the two be the same. For example, for convenience, the point cloud data in a world coordinate system may be converted into a laser radar coordinate system, and then, edge segmentation processing and ray cluster construction are performed on the point cloud data in the laser radar coordinate system. The laser radar coordinate system is a spatial reference system for describing point cloud data captured by a laser radar sensor. For a case in which the laser radar is mounted on the vehicle, the laser radar coordinate system may also be referred to as a vehicle coordinate system, where an x-axis points to a forward direction of the vehicle, a y-axis points to a right side of the vehicle, and a z-axis generally points vertically upward, and is perpendicular to the ground.

Specifically, after determining the ray origin, the computer device may construct a coordinate system based on the ray origin by using the ray origin as a coordinate origin, the forward direction of the vehicle as a positive direction of the x-axis, the vertically upward direction as a positive direction of the z-axis, and a direction being perpendicular to the x-axis and the z-axis and conforming to a right-hand coordinate system rule as a y-axis, generate rays corresponding to the spatial points by using the ray origin as a start point and each spatial point in the point cloud subset as an end point, select the y-axis of the coordinate system as a reference coordinate axis, determine an included angle between each ray and the reference coordinate axis, i.e., the y-axis, and determine, for any ray, a ray cluster to which the ray belongs according to the included angle corresponding to the ray.

In the above embodiment, by determining the ray origin and the reference coordinate axis corresponding to the point cloud subset, generating the rays corresponding to the spatial points by using the ray origin as the start point and each spatial point in the point cloud subset as the end point, and connecting the spatial points to the same origin through the computer device, the structure and shape in the point cloud data may be seen more clearly, the included angle between each ray and the reference coordinate axis is determined, and the ray cluster to which each ray belongs is determined based on the included angle, so that the distribution condition of the spatial points in the point cloud subset may be analyzed based on the ray cluster, and the analysis accuracy and efficiency on the distribution condition of the spatial points in the point cloud subset may be improved. During subsequent determination of the motion sub-path in the tunnel scene based on the distribution condition of the point cloud data, the recognition accuracy and efficiency of the motion sub-path in the tunnel scene may be improved.

In an embodiment, the process that the computer device determines the ray cluster to which each ray belongs based on the included angle includes the following operations: a ray cluster angle value corresponding to each ray cluster is acquired; and when an angle difference between the included angle and a target ray cluster angle value in the ray cluster angle values meets an angle difference threshold, the ray corresponding to the included angle is divided into a ray cluster corresponding to the target ray cluster angle value.

The angle difference threshold is a maximum difference value, allowed by the ray cluster, between the ray and the corresponding ray cluster angle value, and it may be set according to an actual requirement. When there are many spatial points in the point cloud subset, to reduce the calculation amount, the angle difference threshold may be set to be a small value to realize sparse sampling of spatial points during ray cluster construction. When there are few spatial points in the point cloud subset, to improve the accuracy, the angle difference threshold may be set to be a large value to ensure that enough rays may be classified into the suitable ray cluster even when there are few spatial points.

The ray cluster angle value is a predefined value for representing an angle feature of a ray cluster. For example, 18 ray clusters are predefined according to an actual requirement, and a specific angle value is allocated to each ray cluster. The position of the ray origin is the position of the laser radar when the point cloud subset is collected. It may be determined that angle distribution of the 18 ray clusters needs to cover a range of 180 degrees. To avoid an error caused by few spatial points at left and right endpoints of the point cloud subset, a ray cluster may be defined every 10 degrees by starting from the position of 5 degrees to obtain a ray cluster set. A ray cluster angle value set corresponding to the ray cluster set is ϑ=(θᵢ=5+i*10, i=0, 1, . . . , 17).

Specifically, for any one ray, after the included angle between the ray and the reference coordinate axis is determined, the angle difference between the included angle and each ray cluster angle value may be respectively determined, and each angle difference is compared with the angle difference threshold. When the angle difference between the included angle and the target ray cluster angle value is smaller than the angle difference threshold, the ray corresponding to the included angle is divided into the ray cluster corresponding to the target ray cluster angle value.

In an embodiment, when a relationship among the included angle θ, the ray cluster angle value θᵢ, and the angle difference threshold ε meets the following relationship, the ray corresponding to the included angle θ is divided into the ray cluster corresponding to the target ray cluster angle value θᵢ. In an embodiment of this application, the value of ε may be 0.2 degree:

$$\vert θ - {θ}_{i} \vert < ε$$

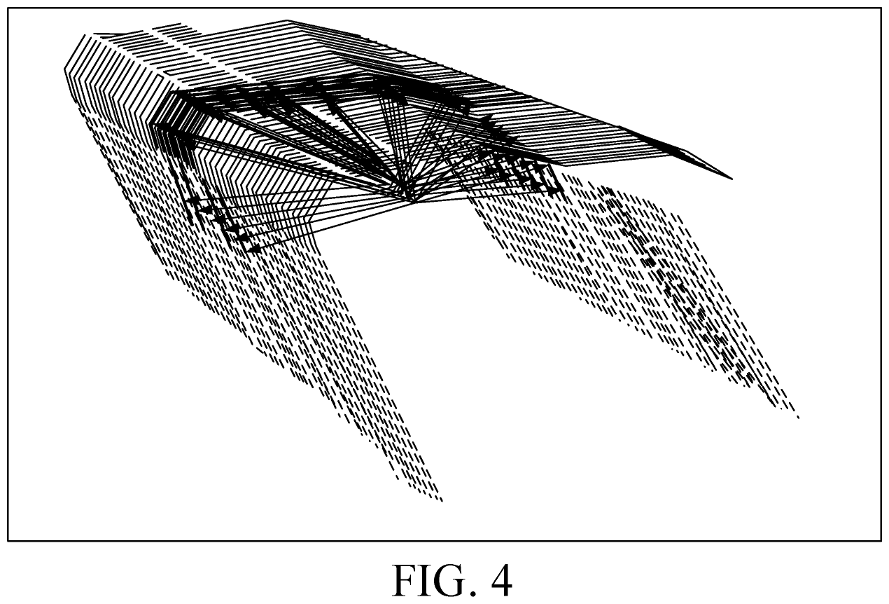

FIG. 4 is a schematic diagram of ray clusters corresponding to a plurality of point cloud subsets of a sampling path point in an embodiment. Rays shown in the figure are rays of corresponding ray clusters, and an included angle between the ray and the reference coordinate axis is a ray cluster angle value corresponding to the corresponding ray cluster.

In the above embodiment, the computer device obtains the ray cluster angle value corresponding to each ray cluster, and adds the ray corresponding to the included angle to the ray cluster corresponding to the target ray cluster angle value when the angle difference between the included angle and the target ray cluster angle value in the ray cluster angle values meets the angle difference threshold, so that the ray may be accurately classified into the corresponding ray cluster, and misclassification may be avoided. During subsequent analysis on the distribution condition of the spatial points in the point cloud subset based on the ray cluster, the analysis accuracy and efficiency on the distribution condition of the spatial points in the point cloud subset may be improved. During subsequent determination of the motion sub-path in the tunnel scene based on the distribution condition of the point cloud data, the recognition accuracy of the motion sub-path in the tunnel scene may be improved. By adjusting the angle difference threshold, the point cloud data of various complexities may be flexibly processed to adapt to different scenes and requirements.
S208: Determine closed-distribution characteristics of the spatial points in each point cloud subset based on a first distance between each spatial point in the ray cluster corresponding to the point cloud subset and the ray origin; and determine continuous-distribution characteristics of the spatial points in each point cloud subset based on a second distance between the center point of the ray cluster and the ray origin.

The closed-distribution characteristics and the continuous-distribution characteristics of the spatial points in the point cloud subset are two distribution characteristics of the spatial points in the point cloud subset, and these distribution characteristics refer to a distribution mode and a geometrical attribute of the spatial points in the point cloud subset. The closed-distribution characteristics are configured for describing whether the distribution of the spatial points in the point cloud subset forms a closed structure or not, for example, a boundary surrounding a region or shape may be specifically closed or unclosed. The “closed” means that the distribution of the spatial points in the point cloud subset forms a closed contour or boundary, such as a circle or a polygon, and indicates high closeness. The “unclosed” means that the distribution of the spatial points in the point cloud subset does not form a closed structure, for example, linear distribution or scattered distribution. The continuous-distribution characteristics are configured for describing whether the distribution of the spatial point in the point cloud subset is continuous or not, and it may be specifically continuous or discontinuous. The “continuous” means that the distribution of the point cloud subset in space is smooth and uniform without significant gaps or breaks. The “discontinuous” means that the distribution of the point cloud subset in space is non-uniform, intermittent, or irregular.

The center point refers to a feature point determined based on the spatial points in the ray cluster. The feature point is configured for geometrically and integrally representing the ray cluster, and may be specifically a center of mass or a center of symmetry of the ray cluster.

Specifically, for any one ray cluster, the computer device may determine the first distance between each spatial point and the ray origin based on position coordinates of each spatial point in the ray cluster and position coordinates of the ray origin, determine position coordinates of the center point of the ray cluster based on the position coordinates of each spatial point, determine a second distance between the center point and the ray origin based on the position coordinates of the center point and the position coordinates of the ray origin, and determine the closed-distribution characteristics and the continuous-distribution characteristics of the spatial points in the point cloud subset based on the first distance and the second distance corresponding to each ray cluster in the point cloud subset.
S210: Recognize a motion sub-path in a tunnel scene in the motion path based on the closed-distribution characteristics and the continuous-distribution characteristics of respective spatial points in the plurality of point cloud subsets.

In an embodiment, if the point cloud data corresponding to the position of the motion path is obtained by screening all the original point cloud data in the point cloud data set corresponding to the motion path, after obtaining the closed-distribution characteristics and the continuous-distribution characteristics of the spatial points in each point cloud subset, the computer device determines the motion sub-path corresponding to each point cloud subset in the motion path, and when the closed-distribution characteristics of the spatial points in the target point cloud subset indicate that the point cloud subset is in a closed state and the continuous-distribution characteristics indicate that the point cloud subset is continuous, the target point cloud subset is determined to be a tunnel point cloud subset, and the motion sub-path corresponding to the target point cloud subset in the motion path is recognized to be the motion sub-path in the tunnel scene. If the motion sub-path in the tunnel scene may be recognized from the motion path, it indicates that the tunnel scene is recognized. If the motion sub-path in the tunnel scene cannot be recognized from the motion path, it indicates that no tunnel scene is recognized.

In an embodiment, if the point cloud data corresponding to the position of the motion path is obtained by screening the original point cloud data corresponding to the sampling path points in the motion path, for any one sampling path point in the motion path, after obtaining the closed-distribution characteristics and the continuous-distribution characteristics of the spatial points in each point cloud subset of the sampling path point, the computer device may determine whether the distribution of the point cloud data corresponding to the sampling path point is matched with typical characteristics of the tunnel scene or not based on the closed-distribution characteristics and the continuous-distribution characteristics of the spatial points in each point cloud subset. A tunnel usually presents a closed and continuous structure, and the shape and size thereof keep consistent within certain range. When the distribution of the point cloud data corresponding to the sampling path point is matched with the typical characteristics of the tunnel scene, it may be determined that the sampling path point is in the tunnel scene, so that the sampling path point in the tunnel scene in the motion path may be determined, and the motion sub-path in the tunnel scene is recognized according to the sampling path point in the tunnel scene in the motion path.

The above tunnel scene recognition method provides a new solution for recognizing the tunnel scene. The computer device performs point cloud segmentation on the point cloud data of the vehicle corresponding to the position of the motion path, and analyzes the distribution condition of each point cloud subset. The closed-distribution characteristics and the continuous-distribution characteristics, capable of reflecting distribution characteristics of the point cloud data, of spatial points in the plurality of point cloud subsets may be obtained without the need of analyzing all the point cloud data, and further, a motion sub-path which is in the motion path and belongs to the tunnel scene may be recognized based on the closed-distribution characteristics and the continuous-distribution characteristics of the spatial points in the plurality of point cloud subsets, and the recognition efficiency of the motion sub-path in the tunnel scene is improved. By performing point cloud segmentation on the point cloud data and determining the ray cluster to which each spatial point in the obtained point cloud subset belongs, the closed-distribution characteristics and the continuous-distribution characteristics of the spatial points in the point cloud subset may be accurately and rapidly determined based on the first distance between each spatial point in the ray cluster and the ray origin as well as the second distance between the center point of the ray cluster and the ray origin, so as to subsequently determine the motion sub-path in the tunnel scene in the motion path based on the closed-distribution characteristics and the continuous-distribution characteristics of the spatial points in each point cloud subset, and the recognition accuracy and efficiency of the motion sub-path in the tunnel scene are further improved.

In an embodiment, the process that the computer device acquires the point cloud data corresponding to the position of the motion path of the vehicle includes the following operations: at least two frames of original point cloud data corresponding to the sampling path points in the motion path are extracted from a point cloud data set corresponding to the position of the motion path of the vehicle; registration stitching is performed on the at least two frames of original point cloud data to obtain stitched point cloud data; and point cloud data meeting a height condition is selected from the stitched point cloud data.

The registration stitching refers to aligning two or more frames of point cloud data in space to form a unified and continuous three-dimensional representation.

Specifically, after obtaining the motion path of the vehicle, the computer device may further perform sparse sampling on the motion path to obtain each sampling path point. For each sampling path point, a frame of original point cloud data collected at the position corresponding to the sampling path point is extracted from the point cloud data set, and the original point cloud data of adjacent frames of the frame of original point cloud data in the point cloud data set is acquired to obtain at least two frames of original point cloud data. Registration stitching is performed on the at least two frames of original point cloud data by using a preset registration algorithm to obtain stitched point cloud data, and a height threshold corresponding to the height condition is obtained. Each spatial point with the height greater than or equal to the height threshold is selected from the stitched point cloud data to obtain the point cloud data meeting the height condition.

Each spatial position coordinate in the original point cloud data may be specifically a coordinate in the laser radar coordinate system. During stitching of the original point cloud data, coordinate system conversion may be first performed on a left position of the original point cloud data to obtain the position coordinate of the original point cloud data in the world coordinate system, and the at least two frames of original point cloud data are registered and stitched in the world coordinate system.

For example, an initial attitude T_{wv} of a vehicle body coordinate system in the world coordinate system may be determined according to devices such as the GPS and the IMU mounted on the vehicle, and an initial laser radar extrinsic parameter of the laser radar is used as a transformation matrix Tᵥₗ from the vehicle body coordinate system to the laser radar coordinate system, so that a pose T_{wl} of the coordinate origin of the laser radar in the world coordinate system may be determined according to the transformation matrix Tᵥₗ and the initial attitude T_{wv}. A transformation relationship involved in the above process is as follows:

$${T}_{wl} = {T}_{wv} \cdot {T}_{vl}$$

Position coordinates of a spatial point P in any one extracted frame of original point cloud data in the laser radar coordinate system may be recorded as P(X,Y,Z). Based on the pose T_{wl} of the coordinate origin of the laser radar in the world coordinate system, by using the following transformation relationship, the position coordinates of the spatial point P in any one frame of original point cloud data may be converted into the coordinates in the world coordinate system. The transformation relationship is as follows:

$${P}_{w} = {T}_{wl} \cdot P$$

Through the coordinate transformation on the at least two frames of original point cloud data, at least two frames of original point cloud data in the world coordinate system are obtained, and the at least two frames of original point cloud data are registered and stitched in the world coordinate system, to obtain the stitched point cloud data which is more uniformly distributed. In addition, in a laser radar scanning process, due to the blocking by interfering objects, a scanned frame of point cloud data may be insufficiently accurate due to voiding. The problem of voiding caused by the blocking may be alleviated by performing registration stitching on the at least two frames of original point cloud data, so the recognition accuracy during scene recognition based on the stitched point cloud data may be improved.

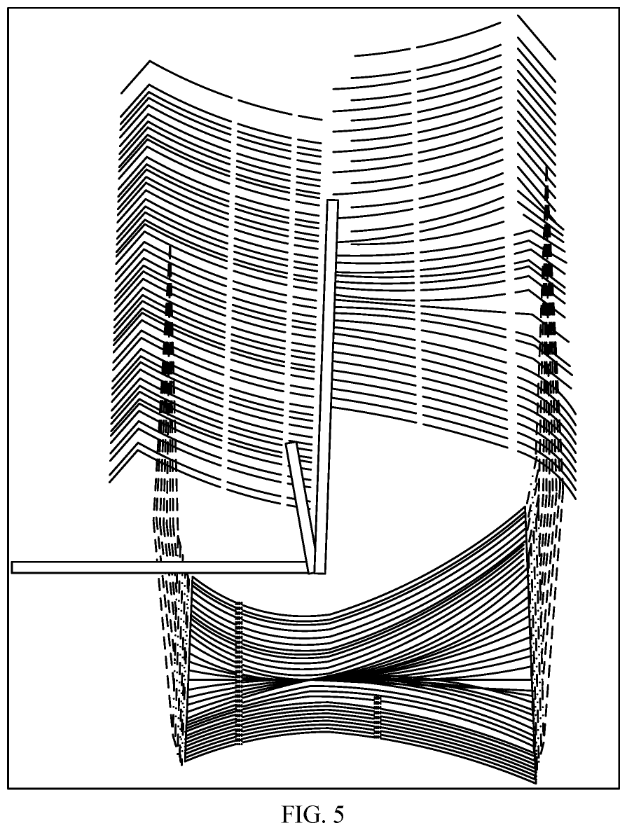

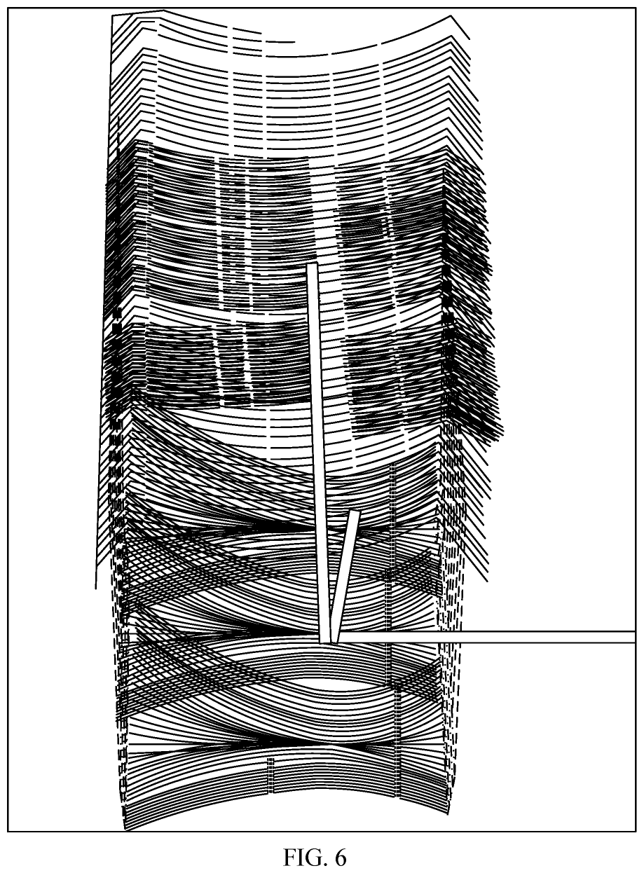

FIG. 5 is a schematic diagram of a single-frame point cloud data according to an embodiment, and FIG. 6 is a schematic diagram of stitched point cloud data according to an embodiment, which shows stitched point cloud data obtained after performing registration stitching on a plurality of frames of original point cloud data. From the figures, it may be seen that the overall distribution of the stitched point cloud data is uniform.

In the above embodiment, the computer device performs registration stitching on at least two frames of original point cloud data, and more continuous and complete point cloud data corresponding to the sampling path points may be obtained, so that the problem of missing that may be encountered during processing of a single frame of data is reduced, and the recognition accuracy of the motion sub-path in the tunnel scene is improved. In addition, by selecting the point cloud data meeting the specific height condition, interfering elements (such as pedestrians, vehicles, and pavement markings) on the ground may be favorably eliminated to realize the focus on a key structure such as a tunnel roof, the interference of an irrelevant element on the tunnel scene recognition is avoided, and the recognition accuracy and recognition efficiency of the motion sub-path in the tunnel scene are improved.

In an embodiment, the process that the computer device segments the spatial points in the point cloud data according to the spatial positions to obtain a plurality of point cloud subsets includes the following operations: a segmentation plane, a point cloud subset size, and a point cloud subset interval of the point cloud data are determined; a point cloud subset coordinate condition is determined based on the segmentation plane, the point cloud subset size, and the point cloud subset interval; and spatial points, in the point cloud data, meeting the same point cloud subset coordinate condition are divided into the same point cloud subset to obtain a preset quantity of point cloud subsets.

The segmentation parameters may specifically include the segmentation plane, the point cloud subset size, and the point cloud subset interval. The segmentation plane is a two-dimensional plane, and is configured for segmenting the point cloud data into smaller parts. The segmentation plane may be determined according to an actual requirement. For example, the segmentation plane may be a horizontal plane, a vertical plane, or a plane at any angle. A spatial range covered by the point cloud subset is preset according to the point cloud subset size. For example, one point cloud subset may be set to cover a space having a thickness of 2 cm, 5 cm, or 10 cm. The point cloud subset interval refers to a distance between adjacent point cloud subsets during point cloud segmentation of the point cloud data. The point cloud subset interval determines whether there is an overlap or a gap between the point cloud subsets. A smaller interval may cause an overlap between the point cloud subsets, and a larger interval may cause a gap between data. In the embodiments of this application, the point cloud subsets are obtained by sparsely sampling the point cloud data. Therefore, the point cloud subset interval is set to meet that there is certain gap between the adjacent point cloud subsets.

The segmentation plane, the point cloud subset size, and the point cloud subset interval may be selected according to an objective of analyzing the point cloud data. Specifically, a proper segmentation plane of the point cloud data may be determined according to a data analysis objective of recognizing the motion sub-path of the tunnel scene. For example, in the embodiments of this application, the objective is to recognize the tunnel scene. For the point cloud data in the tunnel scene, a plane parallel to a cross section of the point cloud data may be selected as the segmentation plane, and the cross section of the point cloud data refers to a plane perpendicular to the traveling direction of the vehicle, or an inclined plane obtained after the cross section is rotated around a common edge between a horizontal plane (which may also be referred to as the ground) and the cross section for certain angle may also be selected. Such a segmentation plane may help effectively retain the tunnel scene characteristics in the point cloud subset to provide convenience for subsequent analysis. The point cloud subset size may be determined according to the data precision and coverage range required during the recognition of the motion sub-path in the tunnel scene. For example, a thinner point cloud subset provides higher precision, and a thicker point cloud subset covers a wider area. The point cloud subset interval may be determined according to the processing efficiency required during the recognition of the motion sub-path in the tunnel scene. For example, a smaller interval may be selected to increase the quantity and the coverage degree of the point cloud subsets, and a larger interval may be selected to reduce the quantity of the point cloud subsets, so that the processing efficiency is improved.

The point cloud subset coordinate condition refers to a condition configured for determining which spatial points are included in each point cloud subset during point cloud segmentation of the point cloud data.

Specifically, after the segmentation plane, the point cloud subset size, and the point cloud subset interval of the point cloud data are determined, the determined segmentation plane, point cloud subset size, and point cloud subset interval, as well as the point cloud data may be inputted into a point cloud data processing application. The point cloud data processing application analyzes the segmentation plane, the point cloud subset size, and the point cloud subset interval to determine the coordinate condition of each point cloud subset, and the spatial points, in the point cloud data, meeting the same point cloud subset coordinate condition are divided into the same point cloud subset to obtain a preset quantity of point cloud subsets.

In the above embodiment, the computer device determines the segmentation plane, the point cloud subset size, and the point cloud subset interval of the point cloud data, and determines the point cloud subset coordinate condition based on the segmentation plane, the point cloud subset size, and the point cloud subset interval, so that the spatial points, in the point cloud data, meeting the same point cloud subset coordinate condition may be divided into the same point cloud subset to obtain a preset quantity of point cloud subsets. Large-scale point cloud data is segmented into smaller segments, so that the analysis and processing of a specific region or structure become more manageable, the distribution characteristics of the point cloud data may be accurately and rapidly determined, and the recognition accuracy and recognition efficiency of the motion sub-path in the tunnel scene in the subsequent process of determining the motion sub-path in the tunnel scene based on the distribution characteristics of the point cloud data may be improved.

In an embodiment, the process that the computer device determines the segmentation plane, the point cloud subset size, and the point cloud subset interval includes: scanning parameters of a multi-beam laser radar configured to collect the point cloud data are acquired; the segmentation plane is determined based on a central scanning beam direction and a scanning direction; the point cloud subset size is determined based on a number of laser beams and a field-of-view angle; and the point cloud subset interval is determined based on a vehicle traveling speed and a scanning frequency.

The laser radar used in the embodiments of this application may be specifically the multi-beam laser radar, for example, 64-beam laser radar. The scanning parameters include the vehicle traveling speed, the number of laser beams, the field-of-view angle, the central scanning beam direction, the scanning direction and the scanning frequency of the multi-beam laser radar.

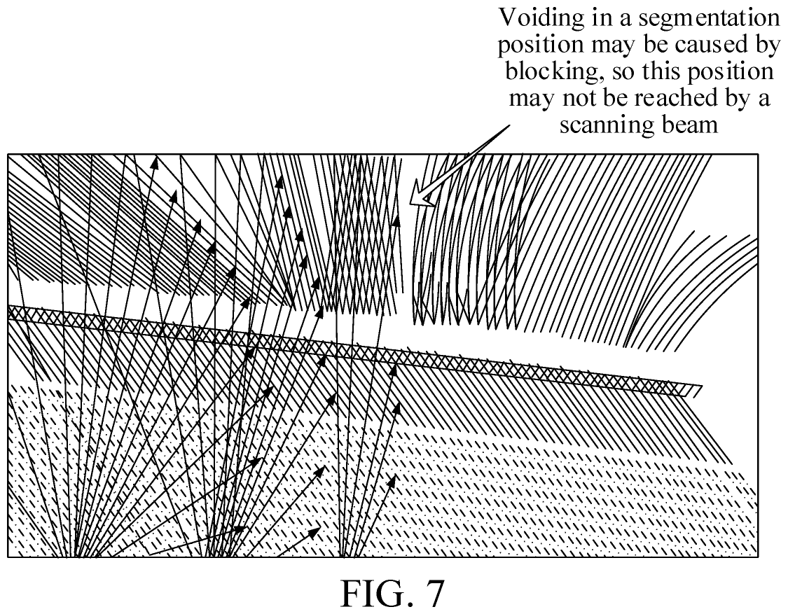

There is an inclined angle between a central scanning beam of the laser radar mounted on the vehicle and the horizontal plane. FIG. 7 is a schematic diagram of point cloud data according to another embodiment. In the scanning process, when there is an obstacle in a beam path of the scanning beam, a void (as shown in FIG. 7) may be formed behind the obstacle along the beam path. If the segmentation plane is specifically the plane parallel to the cross section of the point cloud data, i.e., the section is segmented in a vertical direction, the obtained point cloud subset cannot completely reflect the environmental characteristics, and the accuracy of a subsequent tunnel scene recognition result may be affected. If the segmentation plane is the inclined plane obtained after the cross section is rotated around the common edge between the horizontal plane (which may also be referred to as the ground) and the cross section for certain angle, and the angle is equal to the inclined angle between the central scanning beam and the horizontal plane, the segmentation plane is parallel to a scanning plane determined by the central scanning beam in the laser radar scanning process, and the obtained point cloud subset may completely reflect the environment characteristics, so that the accuracy of the subsequent tunnel scene recognition result may be improved. Therefore, according to the data analysis objective of recognizing the motion sub-path of the tunnel scene, the scanning plane may be determined in combination with the central scanning beam direction and the scanning direction of the multi-beam laser radar, and the section plane may be determined to be a plane parallel to the scanning plane.

The number of laser beams refers to the quantity of laser beams simultaneously emitted by the multi-beam laser radar. A larger number of laser beams indicates a higher vertical resolution of the radar, and finer vertical details may be captured. The field-of-view angle refers to a vertical range covered by the radar scanning. A wider field-of-view angle means that the radar may capture data in a wider vertical range. Specifically, the point cloud subset size may be determined according to the data precision and the coverage range required during recognition of the motion sub-path in the tunnel scene in combination with the number of laser beams and the field-of-view angle.

The vehicle traveling speed and the scanning frequency determine a scanning range of each frame of point cloud data, a preset quantity of point cloud subsets is determined according to the processing efficiency required during recognition of the motion sub-path in the tunnel scene, and the point cloud subset interval is determined according to the preset quantity of point cloud subsets and the scanning range.

In the above embodiment, by acquiring the scanning parameters of the multi-beam laser radar configured to collect the point cloud data, the computer device may determine the proper segmentation plane, point cloud subset size, and point cloud subset interval based on the scanning parameters of the multi-beam laser radar, so as to ensure that the important spatial characteristics of the point cloud data are captured during the point cloud segmentation of the point cloud data based on the segmentation plane, the point cloud subset size, and the point cloud subset interval, so that the distribution characteristics of the point cloud data may be accurately and rapidly determined, and during the subsequent determination of the motion sub-path in the tunnel scene based on the distribution characteristics of the point cloud data, the recognition accuracy and the recognition efficiency of the motion sub-path in the tunnel scene may be improved.

In an embodiment, the process that the computer device determines the closed-distribution characteristics of the spatial points in the point cloud subset based on the first distance between each spatial point in the ray cluster and the ray origin; determines the center point of the ray cluster based on the spatial point in the ray cluster, and determines the continuous-distribution characteristics of the spatial points in the point cloud subset based on the second distance between the center point and the ray origin includes the following operations: the closed-distribution characteristics of the spatial points in the point cloud subset are determined based on the first distance between each spatial point in the ray cluster and the ray origin; and the center point of the ray cluster is determined based on the spatial point in the ray cluster, and the continuous-distribution characteristics of the spatial points in the point cloud subset are determined based on the second distance between the center point and the ray origin.

Specifically, for the spatial points in any one ray cluster, the first distances between the spatial points and the ray origin are respectively determined, the consistent distribution condition of the spatial points in the ray cluster is determined based on the first distance between each spatial point and the ray origin, and the closed-distribution characteristics of the spatial points in the point cloud subset are determined based on the consistent distribution condition of the spatial points in each ray cluster in the point cloud subset; and for any ray cluster, the second distance from a target binding point of the ray cluster to the ray origin is determined, and the continuous-distribution characteristics of the spatial points in the point cloud subset are determined based on the relationship between second distances of adjacent ray clusters in the point cloud subset.

In the above embodiment, the computer device determines the closed-distribution characteristics and the continuous-distribution characteristics of the spatial points in the point cloud subset by calculating the distance between each spatial point in the ray cluster and the ray origin, and the point cloud data may be more deeply and more accurately analyzed, so that the recognition accuracy of the motion sub-path in the tunnel scene during the subsequent determination of the motion sub-path in the tunnel scene based on the closed-distribution characteristics and the continuous-distribution characteristics of the spatial points in the point cloud subset may be improved.

In an embodiment, the process that the computer device determines the closed-distribution characteristics of the spatial points in the point cloud subset based on the first distance between each spatial point in the ray cluster and the ray origin includes the following operations: the first distance between each spatial point and the ray origin is determined; when a difference value between a maximum value and a minimum value of the first distances meets a first distance difference condition, the ray cluster is determined to be a candidate ray cluster; and the closed-distribution characteristics of the spatial points in the point cloud subset are determined based on a proportion of the candidate ray clusters in the ray clusters of the point cloud subset.

The first distance difference condition is configured for determining whether the spatial points corresponding to the rays in the ray cluster may form a closed structure or not. Specifically, the first distance difference threshold may be greater than or equal to a preset first distance difference threshold.

Specifically, for any one ray cluster, the first distance between the spatial point corresponding to each ray in the ray cluster and the ray origin is determined, a maximum value and a minimum value of the first distances are selected from the obtained first distances, a difference value between the maximum value and the minimum value is determined, and the difference value is compared with the preset first distance difference threshold. When the difference value is smaller than the preset first distance difference threshold, the ray cluster is determined to be a candidate ray cluster to learn whether each ray cluster in the point cloud subset is a candidate ray cluster or not. The quantity of the candidate ray clusters in the ray clusters of the point cloud subset is counted, and a ratio of the quantity of the candidate ray clusters to all the ray clusters in the point cloud subset is determined. When the ratio is greater than or equal to a first preset ratio, the closed-distribution characteristics of the spatial points in the point cloud subset are determined to be closed, and when the ratio is smaller than the first preset ratio, the closed-distribution characteristics of the spatial points in the point cloud subset are determined to be unclosed.

In an embodiment, when the relationship among the maximum value max(dᵢⱼ) of the first distance and the minimum value min(dᵢⱼ) of the first distance of the ray cluster, and the first distance difference threshold ∈ meets the following relationship, the ray cluster is determined to be a candidate ray cluster. In the embodiments of this application, ∈ may be 1 m:

$$\vert max ( {d}_{ij} ) - min ( {d}_{ij} ) \vert < ϵ$$

In an embodiment, when the relationship among the quantity N_{valid} of the candidate ray clusters, the quantity N of the ray clusters, and the first preset ratio δₙ meets the following relationship, the closed-distribution characteristics of the spatial points in the point cloud subset are determined to be closed. In the embodiments of this application, δₙ may be 0.833:

$$\frac{{N}_{valid}}{N} \leq {δ}_{n}$$

When there is no ray corresponding to the spatial point in a ray cluster, the ray cluster may be directly determined to be a non-candidate ray cluster.

In the above embodiment, the computer device determines the first distance between each spatial point and the ray origin; when the difference value between the maximum value and the minimum value of the first distances meets the first distance difference condition, the ray cluster is determined to be a candidate ray cluster; and the closed-distribution characteristics of the spatial points in the point cloud subset are determined based on the proportion of the candidate ray clusters in the ray clusters of the point cloud subset, so that whether the point cloud subset forms a closed structure or not may be more accurately determined, and the recognition accuracy of the motion sub-path in the tunnel scene during the subsequent determination of the motion sub-path in the tunnel scene based on the closed-distribution characteristics and the continuous-distribution characteristics of the spatial points in the point cloud subset may be improved.

In an embodiment, the process that the computer device determines the center point of the ray cluster based on the spatial points in the ray cluster, and determines the continuous-distribution characteristics of the spatial points in the point cloud subset based on the second distance between the center point and the ray origin includes the following operations: when the closed-distribution characteristics indicate that the point cloud subset is in a closed state, the second distance between the center point of each candidate ray cluster in the point cloud subset and the ray origin is determined; when the difference value between the second distance of the candidate ray cluster and the second distance of an adjacent candidate ray cluster meets a second distance difference condition, the candidate ray cluster is determined to be a normal ray cluster; and the continuous-distribution characteristics of the spatial points in the point cloud subset are determined based on a proportion of the normal ray clusters in the candidate ray clusters of the point cloud subset.

The second distance difference condition is configured for determining whether the spatial points corresponding to the rays in the ray cluster may be continuously distributed or not. Specifically, the second distance difference threshold may be greater than or equal to a preset second distance difference threshold.

Specifically, for any one candidate ray cluster, the center point of the candidate ray cluster is determined, the second distance between the center point and the ray origin is determined, and the second distance of the candidate ray cluster is respectively compared with the second distances of the left and right adjacent candidate ray clusters. When the difference value between the second distance of the candidate ray cluster and the second distance of the left adjacent candidate ray cluster is smaller than the preset second distance difference threshold, and the difference value between the second distance of the candidate ray cluster and the second distance of the right adjacent candidate ray cluster is smaller than the preset second distance threshold, the candidate ray cluster is determined to be a normal ray cluster to learn whether each candidate ray cluster in the point cloud subset is a normal ray cluster or not. The quantity of normal ray clusters in the candidate ray clusters of the point cloud subset is counted, and a ratio of the quantity of the normal ray clusters to the candidate ray clusters in the point cloud subset is determined. When the ratio is greater than or equal to a second preset ratio, the continuous-distribution characteristics of the spatial points in the point cloud subset are determined to be continuous, and when the ratio is smaller than the second preset ratio, the continuous-distribution characteristics of the spatial points in the point cloud subset are determined to be discontinuous.

In an embodiment, when the relationship among the second distance d̅ᵢ of any one candidate ray cluster, the second distance d̅ᵢ₋₁ of the left adjacent candidate ray cluster, the second distance d̅ᵢ₊₁ of the right adjacent candidate ray cluster, and the second distance difference threshold ∈ₙ meets the following relationship, the candidate ray cluster is determined to be a normal ray cluster. In the embodiments of this application, ∈ₙ may be 5 m:

$$\vert {\overline{d}}_{i} - {\overline{d}}_{i - 1} \vert > {ϵ}_{n} , and \vert {\overline{d}}_{i} - {\overline{d}}_{i + 1} \vert > {ϵ}_{n}$$

In the above embodiment, the computer device determines the second distance between the center point of each candidate ray cluster in the point cloud subset and the ray origin when the closed-distribution characteristics indicate that the point cloud subset is in a closed state; and determines the candidate ray cluster to be a normal ray cluster when the difference value between the second distance of the candidate ray cluster and the second distances of the adjacent candidate ray clusters meets the second distance difference condition. The continuous-distribution characteristics of the spatial points in the point cloud subset may be more accurately determined based on the proportion of the normal ray clusters in the candidate ray clusters of the point cloud subset, so that the recognition accuracy of the motion sub-path in the tunnel scene during the subsequent determination of the motion sub-path in the tunnel scene based on the closed-distribution characteristics and the continuous-distribution characteristics of the spatial points in the point cloud subset may be improved.

In an embodiment, the process that the computer device determines the closed-distribution characteristics of the spatial points in the point cloud subset based on the first distance between each spatial point in the ray cluster and the ray origin; determines the center point of the ray cluster based on the spatial points in the ray cluster, and determines the continuous-distribution characteristics of the spatial points in the point cloud subset based on the second distance between the center point and the ray origin includes the following operations: the first distance between each spatial point and the ray origin is determined; when the difference value between the maximum value and the minimum value of the first distances meets the first distance difference condition, the ray cluster is determined to be of a first candidate type; the second distance between the center point of each ray cluster in the point cloud subset and the ray origin is determined; when the difference value between the second distance of the ray cluster and the second distances of the adjacent ray clusters meets the second distance difference condition, the ray cluster is determined to be of a second candidate type; and the closed-distribution characteristics and the continuous-distribution characteristics of the spatial points in the point cloud subset are determined based on the proportion of the ray clusters being of both the first candidate type and the second candidate type in the point cloud subset.

Specifically, for any one point cloud subset, when a ratio of the quantity of the ray clusters being of both the first candidate type and the second candidate type in the point cloud subset to the quantity of all the ray clusters in the point cloud subset is greater than a preset threshold, the computer device determines the closed-distribution characteristics of the spatial points in the point cloud subset to be closed, and determines the continuous-distribution characteristics of the spatial points in the point cloud subset to be continuous.

In an embodiment, the process that the computer device recognizes the motion sub-path in the tunnel scene from the motion path based on the closed-distribution characteristics and the continuous-distribution characteristics of respective spatial points in the plurality of point cloud subsets includes the following operations: a scene type of the sampling path point is determined based on the closed-distribution characteristics and the continuous-distribution characteristics of the spatial points in the point cloud subsets; and a motion sub-path, which has the scene type being a target type and to which at least two continuous sampling path points belong, in the motion path is determined to be the motion sub-path in the tunnel scene.

The scene type may be specifically a target type or a non-target type, the target type may be a tunnel scene type, and the non-target type may be another type except for the tunnel scene.

Specifically, for any one sampling path point in the motion path, after the closed-distribution characteristics and the continuous-distribution characteristics of the spatial points in each point cloud subset of the sampling path point are obtained, the scene type corresponding to the sampling path point may be determined according to the closed-distribution characteristics and the continuous-distribution characteristics of the spatial points in each point cloud subset, the sampling path point of the target type is marked in the motion path to obtain a marked motion path, and a continuous path segment to which the sampling path point in the scene type being the target type belongs in the marked motion path is determined to be the motion sub-path in the tunnel scene.

In the above embodiment, the computer device determines the scene type by analyzing the closed-distribution characteristics and the continuous-distribution characteristics of the spatial points in the point cloud subset to more precisely recognize a particular scene, such as a tunnel. The motion sub-path, which has the scene type being the target type and to which at least two continuous sampling path points belong, in the motion path is determined to be the motion sub-path in the tunnel scene. The continuous sampling path points are combined, and the whole tunnel section rather than a part of the tunnel may be more accurately recognized, so that the recognition accuracy on the motion sub-path in the tunnel scene is improved.

In an embodiment, the process that the computer device recognizes the motion sub-path in the tunnel scene from the motion path based on the closed-distribution characteristics and the continuous-distribution characteristics of respective spatial points in the plurality of point cloud subsets includes the following operations: the quantity of sampling path points of the non-target scene type between two adjacent motion sub-paths in the tunnel scene is determined, and when the quantity of the sampling path points of the non-target scene type is smaller than a preset quantity threshold, or a distance between the two adjacent motion sub-paths in the tunnel scene is smaller than a preset distance threshold, a sub-path between the two adjacent motion sub-paths in the tunnel scene is determined to be a motion sub-path in a modified tunnel scene.

For example, in a scene of a mountain tunnel, non-open-air tunnel sections of the tunnel may be first recognized, a distance between two adjacent non-open-air tunnel sections is determined, and when the distance is smaller than 200 m, a road section between the two adjacent non-open-air tunnel sections is an open-air section, and is merged with the two adjacent non-open-air tunnel sections to obtain a complete tunnel section.

In an embodiment, the process that the computer device determines the scene type of the sampling path point based on the closed-distribution characteristics and the continuous-distribution characteristics of the spatial points in the point cloud subsets includes the following operations: when the closed-distribution characteristics of the spatial points in the point cloud subset indicate that the point cloud subset is in a closed state and the continuous-distribution characteristics indicate that the point cloud subset is continuous, the point cloud subset is determined to be a candidate tunnel point cloud subset; and when a proportion of the candidate tunnel point cloud subsets in the point cloud subsets corresponding to the sampling path point reaches a proportion threshold, the scene type corresponding to the sampling path point is determined to be the target type.

Specifically, for any one point cloud subset, after the computer device obtains the closed-distribution characteristics and the continuous-distribution characteristics of the spatial points in the point cloud subset, if the closed-distribution characteristics are the closed and the continuous-distribution characteristics are the continuous, i.e., the closed-distribution characteristics indicate that the point cloud subset is in a closed state and the continuous-distribution characteristics indicate that the point cloud subset is continuous, the point cloud subset may be a tunnel or of another similar closed structure, and the point cloud subset is determined to be the candidate tunnel point cloud subset. The proportion of the candidate tunnel point cloud subset in all the point cloud subsets corresponding to each sampling path point is counted, and when the proportion reaches the proportion threshold, the scene type corresponding to the corresponding sampling path point is determined to be the target type, that is, the scene type corresponding to the corresponding sampling path point is determined to be the tunnel scene type.

For example, if the proportion threshold is ½, the quantity of the point cloud subsets corresponding to a sampling path point is 5, and the quantity of the candidate tunnel point cloud subsets is 3, the scene type of the sampling path point is determined to be the tunnel scene type.

In the above embodiment, by evaluating the closeness and the continuity of the point cloud subsets, the computer device may more accurately determine whether the point cloud subset represents a tunnel scene or not, it is helpful to distinguish the tunnel from other similar structures such as a bridge or a culvert. When the proportion of the candidate tunnel point cloud subsets in the point cloud subsets corresponding to the sampling path point reaches the proportion threshold, the scene type corresponding to the sampling path point is determined to be the target type, so that the wrong determination may be avoided, and that the scene type may be determined to be the tunnel type only when there is enough evidence is ensured, so the recognition accuracy of the motion sub-path in the tunnel scene during the subsequent determination of the motion sub-path in the tunnel scene based on the sampling path point of the tunnel type may be improved.

In an embodiment, the tunnel scene recognition method further includes the following operations: in a point cloud map updating process, when a motion sub-path corresponding to target point cloud data is the motion sub-path in the tunnel scene, the target point cloud data is registered with a point cloud map to obtain an updated point cloud map.

The point cloud map refers to an existing point cloud map, and the existing point cloud map is a point cloud map obtained by updating, frame by frame, the point cloud data which has been processed in the point cloud data set. For example, if the point cloud data set corresponding to the motion path includes 20 frames of point cloud data, and processing on the first 9 frames of point cloud data has been completed currently, the point cloud map is obtained based on the first 9 frames of point cloud data.

The target point cloud data refers to point cloud data needing to be processed and analyzed, and it may be specifically a current frame of point cloud data. For example, if the point cloud data set corresponding to the motion path includes 20 frames of point cloud data, and the processing on the first 9 frames of point cloud data has been completed currently, the 10^{th} frame of point cloud data is the target point cloud data.

Specifically, after determining the motion sub-path in the tunnel scene in the motion path, the computer device may determine that in the original point cloud data set, each frame of point cloud data corresponding to the motion sub-path in the tunnel scene is the point cloud data in the tunnel scene. In the point cloud map updating process, when the motion sub-path corresponding to the target point cloud data is the motion sub-path in the tunnel scene, that is, when the target point cloud data is the point cloud data in the tunnel scene, a preset registration algorithm applicable to the tunnel scene is adopted for registering the target point cloud data and the point cloud map to obtain the updated point cloud map.

The preset registration algorithm applicable to the tunnel scene is an algorithm specifically designed for processing the point cloud data in a tunnel environment, and may be specifically an algorithm obtained after parameter adjustment adapted to the tunnel scene on an iterative closest point (ICP) algorithm, feature-based reference registration, standard template matching, and the like.

In the above embodiment, in the point cloud map updating process, the computer device performs special point cloud data registration and map updating for the motion sub-path in the tunnel scene, and the accuracy and practicability of the point cloud map may be significantly improved.

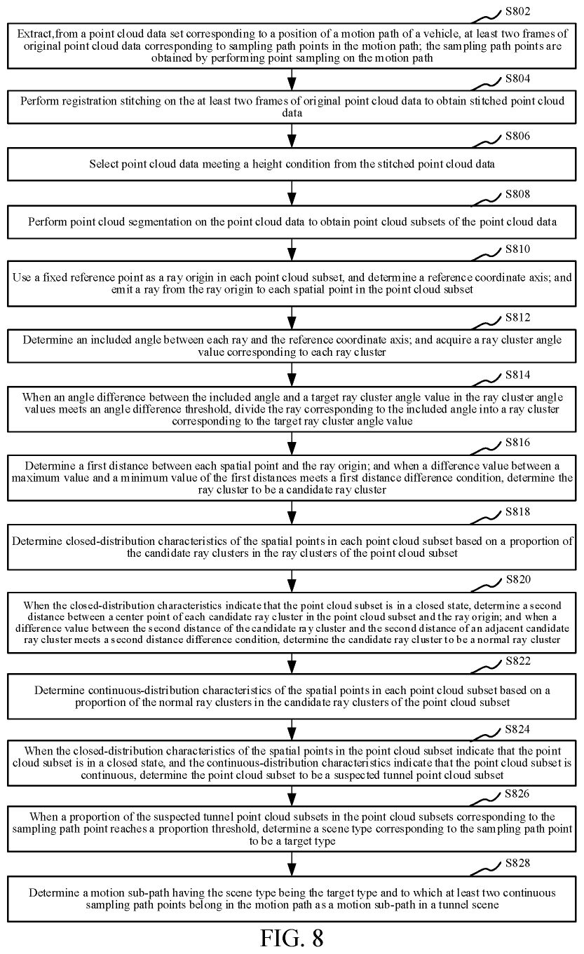

FIG. 8 is a schematic flowchart of a tunnel scene recognition method according to another embodiment. An embodiment that the method is applied to a computer device in FIG. 1 is taken as an example for illustration. The method includes the following operations:
S802: Extract, from a point cloud data set corresponding to a position of a motion path of a vehicle, at least two frames of original point cloud data corresponding to sampling path points in the motion path; the sampling path points are obtained by performing point sampling on the motion path.
S804: Perform registration stitching on the at least two frames of original point cloud data to obtain stitched point cloud data.
S806: Select point cloud data meeting a height condition from the stitched point cloud data.
S808: Perform point cloud segmentation on the point cloud data to obtain point cloud subsets of the point cloud data.
S810: Use a fixed reference point as a ray origin in each point cloud subset, and determine a reference coordinate axis; and emit a ray from the ray origin to each spatial point in the point cloud subset.
S812: Determine an included angle between each ray and the reference coordinate axis; and acquire a ray cluster angle value corresponding to each ray cluster.
S814: When an angle difference between the included angle and a target ray cluster angle value in the ray cluster angle values meets (e.g., is less than) an angle difference threshold, add the ray corresponding to the included angle to the ray cluster corresponding to the target ray cluster angle value.
S816: Determine a first distance between each spatial point and the ray origin; and when a difference value between a maximum value and a minimum value of the first distances meets a first distance difference condition, determine the ray cluster to be a candidate ray cluster.
S818: Determine closed-distribution characteristics of the spatial points in each point cloud subset based on a proportion of the candidate ray clusters in the ray clusters of the point cloud subset.
S820: When the closed-distribution characteristics indicate that the point cloud subset is in a closed state, determine a second distance between a center point of each candidate ray cluster in the point cloud subset and the ray origin; and when a difference value between the second distance of the candidate ray cluster and the second distance of an adjacent candidate ray cluster meets a second distance difference condition, determine the candidate ray cluster to be a normal ray cluster.
S822: Determine continuous-distribution characteristics of the spatial points in each point cloud subset based on a proportion of the normal ray clusters in the candidate ray clusters of the point cloud subset.
S824: When the closed-distribution characteristics of the spatial points in the point cloud subset indicate that the point cloud subset is in a closed state, and the continuous-distribution characteristics indicate that the point cloud subset is continuous, determine the point cloud subset to be a candidate tunnel point cloud subset.
S826: When a proportion of the candidate tunnel point cloud subsets in the point cloud subsets corresponding to the sampling path point reaches a proportion threshold, determine a scene type corresponding to the sampling path point to be a target type.
S828: Determine a motion sub-path having the scene type being the target type and to which at least two continuous sampling path points belong in the motion path as a motion sub-path in a tunnel scene.

This application further provides an application scene, and the tunnel scene recognition method is applied to the application scene. The tunnel scene recognition method specifically includes the following operations:

### 1. Point Sampling and Local Point Cloud Stitching

A collection vehicle acquires a large amount of GPS/IMU information and laser point cloud data on various roads, a complete motion path during collection is determined based on the GPS/IMU information, and the collected laser point cloud data is organized according to the complete motion path to obtain an original point cloud data set. First, data preprocessing is performed on the complete motion path by means of equidistant sampling (for example, at an interval of 2 m) to obtain the motion path; a frame of original point cloud data collected at each path point on the motion path is extracted from the original point cloud data set; and a point cloud data set is formed based on the frame of original point cloud data collected at each path point. Then, point sampling is performed on the motion path by using an interval of 30 m to obtain each sampling path point; a frame of original point cloud data collected at the sampling path point, and two adjacent frames of original point cloud data before and after the frame of original point cloud data are extracted from the point cloud data set to obtain three frames of point cloud data corresponding to the sampling path point, and the three frames of point cloud data are stitched to obtain stitched point cloud data.

### 2. Construction of Point Cloud Ray Cluster

Point cloud segmentation is performed on the stitched point cloud data corresponding to each sampling path point to obtain each point cloud subset.

This solution starts from radar scanning. A point cloud subset segmentation direction and a subsequent ray cluster construction direction are both along a direction parallel to a central scanning beam of a multi-beam laser radar. To achieve this objective, the stitched point cloud

$${P}_{w}^{i}$$

in a world system needs to be back projected to a radar center

$${T}_{wl}^{i}$$

corresponding to a sampling path point i:

$${P}_{l}^{i} = {{T}_{wl}^{i}}^{- 1} \cdot {P}_{w}^{i}$$

Since a z-axis of a laser radar coordinate system is perpendicular to the scanning beam, and an origin thereof is in a center starting point of the scanning beam, only the spatial points with the z value of around 0

$$( i . e . , \vert {z}_{{P}_{l}^{i}} \vert < δ )$$

need to be remained, and these spatial points are obtained through scanning by the central scanning beam. In addition, by considering factors such as a scanning range and a resolution of the laser radar point cloud, and by taking 64-beam laser radar as an example, a field-of-view angle range thereof is −25° to 15°, an average resolution is 0.625°, and a scanning beam interval when the laser scans an object at a distance of 10 m is about 10 cm. Under an actual condition, due to uneven distribution of the laser scanning beams, the middle region has higher resolutions. According to this solution, the middle scanning region is sampled. Therefore, a point cloud subset size is set to 10 cm (i.e., δ=0.05 m), to ensure the coverage range in front and rear directions, each stitched point cloud is segmented for 5 times, and a point cloud subset interval is set to 0.5 m. To avoid the interference of traffic flows, guardrails, pedestrians and the like, which may appear around, on the subsequent tunnel recognition, only the point cloud subsets higher than a particular height (for example, 1 m above the vehicle body, and about 2.5 m from the ground) are reserved.

A bottom midpoint of each point cloud subset is used as the ray origin O, and a ray is emitted from the origin to each spatial point in the point cloud subset. The point cloud having closed characteristics is to form a semi-circle after ray emission. To reduce the calculation amount, sampling is performed at an interval of a particular angle, the angle is used as a candidate angle, and only rays corresponding to the angle are constructed.

A ray cluster angle value corresponding to each ray cluster is preset, an included angle between each ray and a reference coordinate axis is determined, and when an angle difference between the included angle and a target ray cluster angle value in the ray cluster angle values meets an angle difference threshold, the ray corresponding to the included angle is divided into a ray cluster corresponding to the target ray cluster angle value. For example, 18 ray clusters are constructed, and the ray cluster angle value corresponding to each ray cluster is respectively ϑ=(θᵢ=5+i*10, i=0, 1, . . . , 17).

### 3. Tunnel Recognition

For the spatial points corresponding to any one ray cluster, a first distance between each spatial point and the origin is determined, and when a difference value between a maximum value and a minimum value of the first distances meets a first distance difference condition, the ray cluster is determined to be a valid ray cluster; and for any one valid ray cluster Sᵢ, a center of mass p̅ᵢ of the spatial point pᵢⱼ corresponding to the valid ray cluster Sᵢ is taken, and a second distance between the center of mass and the origin is calculated.

$${\overline{p}}_{i} = \frac{1}{\vert {S}_{i} \vert} {\sum }_{j = 0}^{\vert {S}_{i} \vert - 1} {p}_{ij}$$

(1) Closeness: For any one point cloud subset, if a cross section of the point cloud is closed, the quantity N_{valid} of the valid ray clusters in the ray clusters of the point cloud subset is to be equal to or close to (by considering the noise effect) the total quantity N of the ray clusters, and if the quantity difference is large, for example, as shown in the following relationship:

$$\vert N - {N}_{valid} \vert > {δ}_{n}$$

in this embodiment, δₙ=3, then the point cloud subset may be determined to be a non-tunnel type point cloud subset.
(2) Continuity: For any one point cloud subset, an inner surface of a tunnel is basically regular and smooth, and distances between surface points in adjacent regions of the same cross section and a geometric center of the cross section are consistent, so second distances d̅ᵢ, d̅ᵢ₋₁, and d̅ᵢ₊₁ between adjacent ray clusters in the ray clusters and the origin are to be similar. If the deviation is too large, for example, as shown by the following relationship:

$$\vert {\overline{d}}_{i} - {\overline{d}}_{i - 1} \vert > {ϵ}_{n} and \vert {\overline{d}}_{i} - {\overline{d}}_{i + 1} \vert > {ϵ}_{n}$$

in this embodiment, ∈ₙ=5 m, then it is regarded as an abnormal condition. When the quantity of abnormal ray clusters in the valid ray clusters of a point cloud subset exceeds a particular threshold, for example, if it is greater than 3, the point cloud subset is determined to be a non-tunnel type point cloud subset.
(3) Consistency: To further improve the recognition accuracy of the tunnel scene and reduce the interference caused by road elements such as a gantry and dense street trees, in this solution, whether the scene type of the sampling path point is a tunnel scene or not is voted by using the characteristics of tunnel consistency in combination with the tunnel recognition results of all point cloud subsets of each sampling path point. A used voting policy is as follows: when the quantity of the point cloud subsets, in each sampling path point, being determined to be candidate tunnel point cloud subsets is smaller than a preset quantity, the scene type of the sampling path point is determined to be the non-tunnel scene type.
(4) Noise filtration and omission remediation: By considering that a single sampling path point only includes local information, some scenes such as a culvert and an overpass bridge are consistent with that of a tunnel in aspects of local characteristics, but from a global perspective, they are to be distinguished from the tunnel due to their short lengths. Based on this, in this application scene, the tunnel recognition results of continuous sampling path points are assessed, and only when the sampling path points are continuously recognized to be of the tunnel scene type, they may be considered as the path points in the valid tunnel scene. Specifically, if a sampling path point is of the tunnel scene type, and two adjacent sampling path points before and after are of the non-tunnel scene type, the sampling path point may be regarded as a noise to be filtered. After noise filtration, for a scene with an open-air non-tunnel section between tunnels, such as a mountain tunnel, the open-air section is to be merged with the previous and following tunnel sections to form a complete tunnel section, and a merging interval threshold is set to 200 m. Under the effect of the merging policy, after some tunnel sampling path points are incorrectly determined to be non-tunnel sections and are omitted, omission remediation may still be realized since the previous and following sampling path points are all a tunnel type.

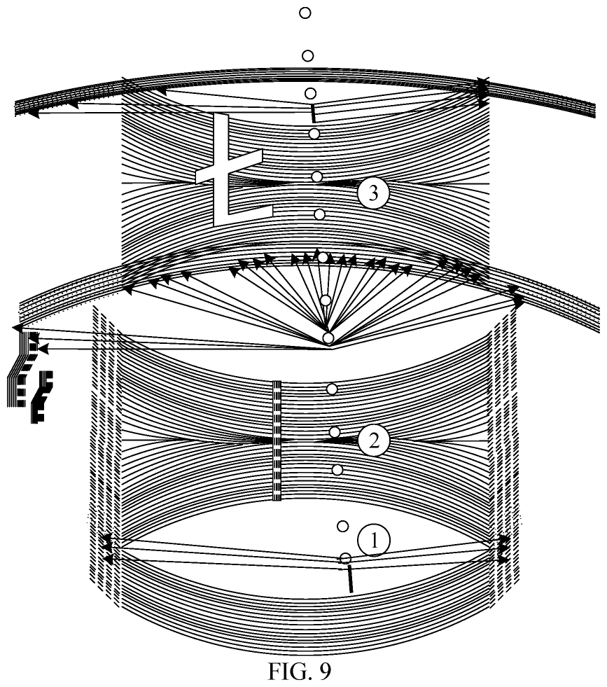

The recognition effect of the tunnel scene recognition method provided in this application is described below respectively by using several real scenes. FIG. 9 is a schematic diagram of point cloud data in a real scene according to an embodiment. Referring to a scene 1 shown in FIG. 9, in a process of recognizing the tunnel scene by using the tunnel scene recognition method provided in this application, the quantity of valid ray clusters in the ray clusters corresponding to the sampling path point (1) and the sampling path point (3) is much smaller than the total quantity of the corresponding ray clusters, and the closeness is not met. Therefore, the scene types corresponding to the sampling path point (1) and the sampling path point (3) are both non-tunnel scenes. The sampling path point (2) meets the closeness and the continuity. The scene type corresponding to the sampling path point (2) is the tunnel scene, but the sampling path point (1) and the sampling path point (3) adjacent to the sampling path point (2) are both in non-tunnel scenes, so the scene 1 is determined to be the non-tunnel scene, and the corresponding motion sub-path is a motion sub-path in the non-tunnel scene.

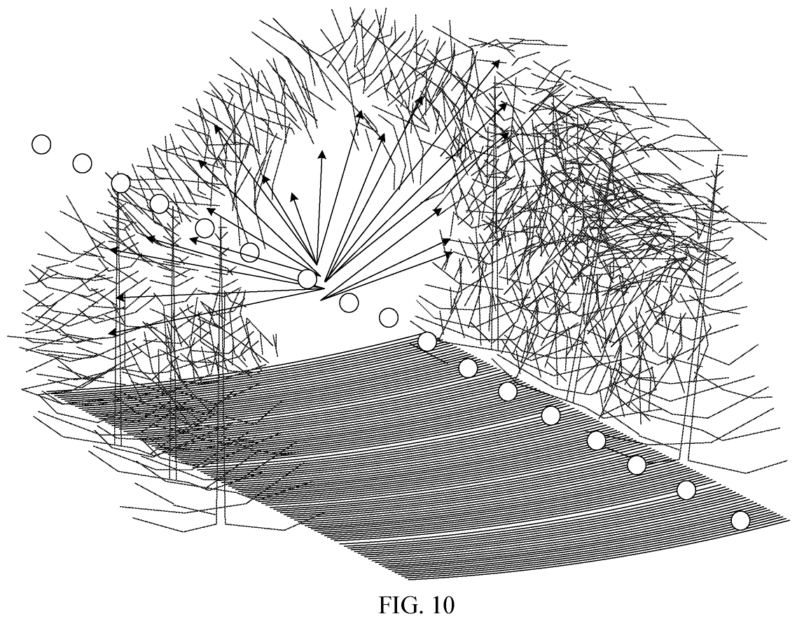

FIG. 10 is a schematic diagram of point cloud data in a real scene according to another embodiment. In the process of recognizing the tunnel scene by using the tunnel scene recognition method provided in this application, the quantity of the valid ray clusters in the ray clusters corresponding to each sampling path point is close to the total quantity of the corresponding ray clusters, and the closeness is met. However, a distance difference between the centers of mass of adjacent ray clusters in the same point cloud subset and the ray origin is large, there are many ray clusters in this case, and the continuity is not met. Therefore, the scene 2 is determined to be the non-tunnel scene, and the corresponding motion sub-path is a motion sub-path in the non-tunnel scene.

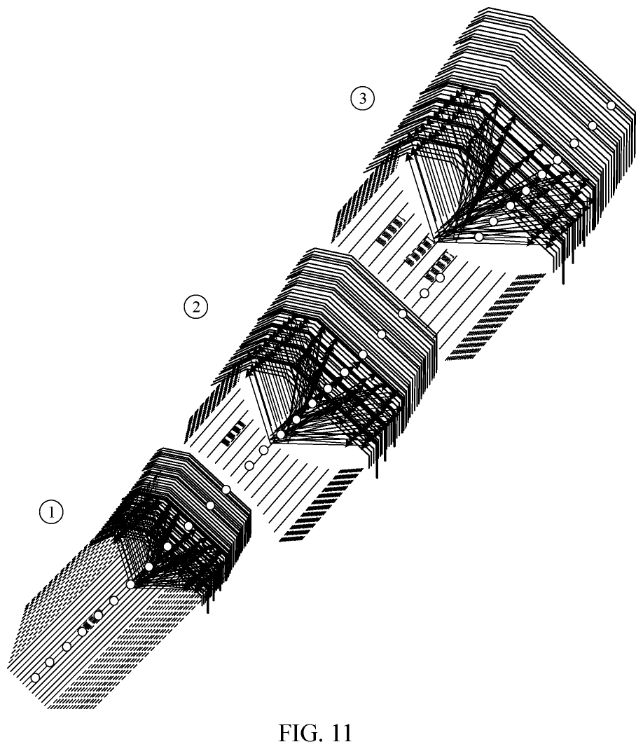

FIG. 11 is a schematic diagram of point cloud data in a real scene according to another embodiment. In the process of recognizing the tunnel scene by using the tunnel scene recognition method provided in this application, in three sampling path points, the ray clusters in the point cloud subset of each sampling path point meet the closeness, the continuity, and the consistency, the scene type of each sampling path point is determined to be the tunnel scene, and the three sampling path points are continuous, so the scene 3 is determined to be the tunnel scene, and the corresponding motion sub-path is a motion sub-path in the tunnel scene. In addition, there is a complex scene of an intersection tunnel at the sampling path point (2), and it may still be accurately recognized by using the tunnel scene recognition method provided in this application.

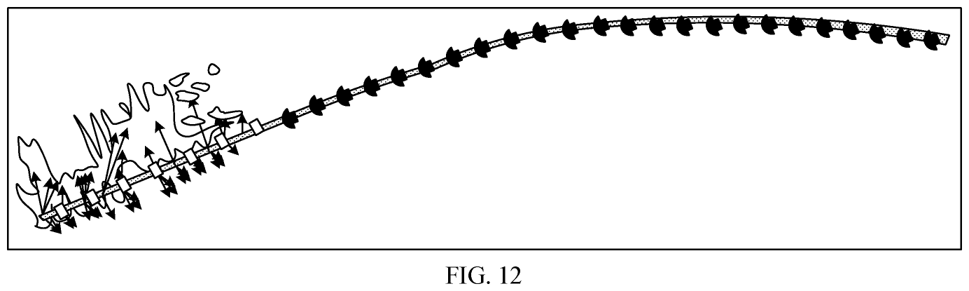

In another real scene, a tunnel scene is recognized by using the tunnel scene recognition method provided in this application, and FIG. 12 is a schematic diagram of point cloud data in a real scene according to another embodiment. In the figure, a part covered by a large-range point cloud on the left is a non-tunnel region, where a white rectangle represents that the scene type of the sampling path point is the non-tunnel scene; and a part covered by a small-range point cloud on the right is a non-tunnel region, where a black umbrella shape represents that the scene type of the sampling path point is the tunnel scene. It can be seen from the figure that the tunnel region in a road may be effectively recognized by using the tunnel scene recognition method provided in this application, and a complete tunnel range may be outputted.

Although the operations are displayed sequentially according to instructions of arrows in the flowcharts of the foregoing embodiments, the operations are not necessarily executed sequentially in an order indicated by the arrows. Unless otherwise explicitly specified herein, an execution sequence of the operations is not limited, and the operations may be executed in other sequences. Moreover, at least some operations in the flowchart involved in each of the foregoing embodiments may include a plurality of operations or a plurality of stages. The operations or stages are not necessarily executed completely at the same moment and may be executed at different moments. The operations or stages are not necessarily executed sequentially, and may be executed alternately with other operations or at least some operations or stages of other operations.

Based on the same inventive concept, an embodiment of this application further provides a tunnel scene recognition apparatus for implementing the above tunnel scene recognition method. The implementation solution to the problem provided by the apparatus is like that described in the foregoing method, so reference may be made to definitions of the above tunnel scene recognition method for specific definitions of one or more tunnel scene recognition apparatus embodiments provided below, which will not be repeated herein.

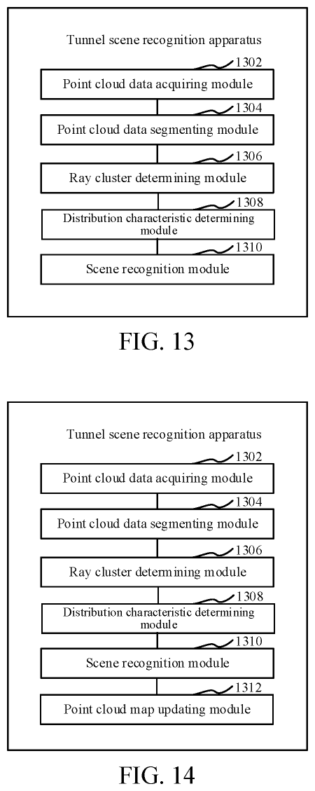

FIG. 13 is a structural block diagram of a tunnel scene recognition apparatus according to an embodiment, which includes: a point cloud data acquiring module 1302, a point cloud data segmenting module 1304, a ray cluster determining module 1306, a distribution characteristic determining module 1308, and a scene recognition module 1310.

The point cloud data acquiring module 1302 is configured to acquire point cloud data corresponding to a position of a motion path of a vehicle.

The point cloud data segmenting module 1304 is configured to segment spatial points in the point cloud data according to spatial positions to obtain a plurality of point cloud subsets.

The ray cluster determining module 1306 is configured to emit, in each point cloud subset, a ray to each spatial point in the point cloud subset by using a fixed reference point as a ray origin, and determine a ray cluster to which the ray belongs.

The distribution characteristic determining module 1308 is configured to determine closed-distribution characteristics of the spatial points in each point cloud subset based on a first distance between each spatial point in each ray cluster and the ray origin; and determine a center point of each ray cluster based on the spatial points in the ray cluster, and determine continuous-distribution characteristics of the spatial points in each point cloud subset based on a second distance between the center point and the ray origin.

The scene recognition module 1310 is configured to recognize a motion sub-path in a tunnel scene from the motion path based on the closed-distribution characteristics and the continuous-distribution characteristics of respective spatial points in the plurality of point cloud subsets.

In the above embodiment, point cloud segmentation is performed on the point cloud data of the vehicle corresponding to the position of the motion path, and a distribution condition of each point cloud subset is analyzed. The closed-distribution characteristics and the continuous-distribution characteristics, capable of reflecting distribution characteristics of the point cloud data, of spatial points in the plurality of point cloud subsets may be obtained without the need of analyzing all the point cloud data, and further, a motion sub-path which is in the motion path and belongs to the tunnel scene may be recognized based on the closed-distribution characteristics and the continuous-distribution characteristics of the spatial points in the plurality of point cloud subsets, and the recognition efficiency of the motion sub-path in the tunnel scene is improved. By performing point cloud segmentation on the point cloud data and determining the ray cluster to which each spatial point in the obtained point cloud subset belongs, the closed-distribution characteristics and the continuous-distribution characteristics of the spatial points in the point cloud subset may be accurately and rapidly determined based on the first distance between each spatial point in the ray cluster and the ray origin as well as the second distance between the center point of the ray cluster and the ray origin, so as to subsequently determine the motion sub-path in the tunnel scene in the motion path based on the closed-distribution characteristics and the continuous-distribution characteristics of the spatial points in each point cloud subset, and the recognition accuracy and efficiency of the motion sub-path in the tunnel scene are further improved.

In an embodiment, the point cloud data acquiring module 1302 is further configured to: extract, from a point cloud data set corresponding to the position of the motion path of the vehicle, at least two frames of original point cloud data corresponding to sampling path points in the motion path; perform registration stitching on the at least two frames of original point cloud data to obtain stitched point cloud data; and select point cloud data meeting a height condition from the stitched point cloud data.

In an embodiment, the point cloud data segmenting module 1304 is further configured to: determine a segmentation plane, a point cloud subset size, and a point cloud subset interval of the point cloud data; determine a point cloud subset coordinate condition based on the segmentation plane, the point cloud subset size, and the point cloud subset interval; and divide spatial points, in the point cloud data, meeting the same point cloud subset coordinate condition into the same point cloud subset to obtain a preset quantity of point cloud subsets.

In an embodiment, the point cloud data segmenting module 1304 is further configured to: acquire scanning parameters of a multi-beam laser radar configured to collect the point cloud data, the scanning parameters including a vehicle traveling speed, and a number of laser beams, a field-of-view angle, a central scanning beam direction, a scanning direction and a scanning frequency of the multi-beam laser radar; determine the segmentation plane based on the central scanning beam direction and the scanning direction; determine the point cloud subset size based on the number of laser beams and the field-of-view angle; and determine the point cloud subset interval based on the vehicle traveling speed and the scanning frequency.

In an embodiment, the ray cluster determining module 1306 is further configured to: determine a ray origin and a reference coordinate axis corresponding to the point cloud subset; generate rays corresponding to the spatial points by using the ray origin as a start point and each spatial point in the point cloud subset as an end point; determine an included angle between each ray and the reference coordinate axis; and determine a ray cluster to which each ray belongs based on the included angle.

In an embodiment, the ray cluster determining module 1306 is further configured to: acquire a ray cluster angle value corresponding to each ray cluster; and when an angle difference between the included angle and a target ray cluster angle value in the ray cluster angle values meets an angle difference threshold, add the ray corresponding to the included angle to the ray cluster corresponding to the target ray cluster angle value.

In an embodiment, the distribution characteristic determining module 1308 is further configured to: determine a first distance between each spatial point and the ray origin; when a difference value between a maximum value and a minimum value of the first distances meets a first distance difference condition, determine the ray cluster to be a candidate ray cluster; determine closed-distribution characteristics of the spatial points in the point cloud subset based on a proportion of the candidate ray clusters in the ray cluster of the point cloud subset.

In an embodiment, the distribution characteristic determining module 1308 is further configured to: when the closed-distribution characteristics indicate that the point cloud subset is in a closed state, determine a second distance between a center point of each candidate ray cluster in the point cloud subset and the ray origin; when a difference value between the second distance of the candidate ray cluster and a second distance of an adjacent candidate ray cluster meets a second distance difference condition, determine the candidate ray cluster to be a normal ray cluster; and determine continuous-distribution characteristics of the spatial points in the point cloud subset based on a proportion of the normal ray clusters in the candidate ray cluster of the point cloud subset.

In an embodiment, the scene recognition module 1310 is configured to: determine a scene type of the sampling path points based on the closed-distribution characteristics and the continuous-distribution characteristics of spatial points in the point cloud subsets; and determine a motion sub-path having a scene type being a tunnel scene type and to which at least two continuous sampling path points belong in the motion path as the motion sub-path in the tunnel scene.

In an embodiment, the scene recognition module 1310 is configured to: when the closed-distribution characteristics of the spatial points in the point cloud subset indicate that the point cloud subset is in a closed state, and the continuous-distribution characteristics indicate that the point cloud subset is continuous, determine the point cloud subset to be a candidate tunnel point cloud subset; and when a proportion of the candidate tunnel point cloud subsets in the point cloud subsets corresponding to the sampling path points reaches a proportion threshold, determine the scene type corresponding to the sampling path points to be the tunnel scene type.

FIG. 14 is a structural block diagram of a tunnel scene recognition apparatus according to another embodiment, the apparatus further including a point cloud map updating module 1312, which is configured to: in a point cloud map updating process, when a motion sub-path corresponding to target point cloud data is the motion sub-path in the tunnel scene, register the target point cloud data with a point cloud map to obtain an updated point cloud map.

The modules in the tunnel scene recognition apparatus may be implemented completely or partially through software, hardware, or a combination thereof. The foregoing modules may be embedded in or independent of a processor in a computer device in a form of hardware, or may be stored in a memory in the computer device in a form of software, such that the processor may invoke and execute operations corresponding to the modules.

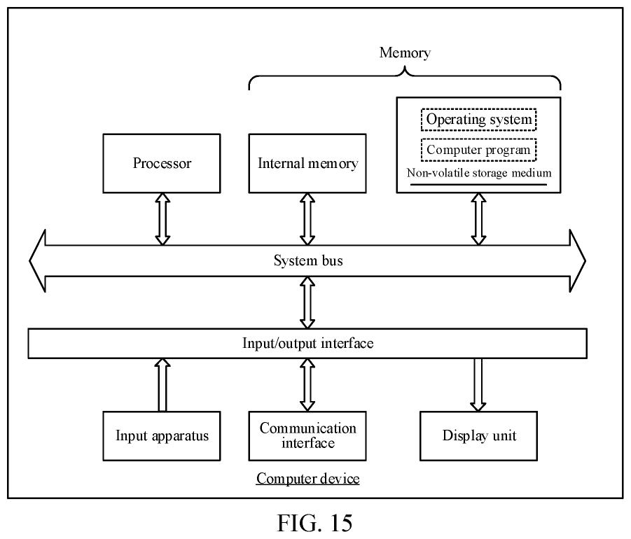

In an embodiment, a computer device is provided. The computer device may be a terminal, and FIG. 15 is an internal structure diagram of a computer device according to an embodiment. The computer device includes a processor, a memory, an input/output interface, a communication interface, a display unit, and an input apparatus. The processor, the memory, and the input/output interface are connected through a system bus, and the communication interface, the display unit, and the input apparatus are connected to the system bus through the input/output interface. The processor of the computer device is configured to provide computing and control capabilities. The memory of the computer device includes a non-volatile storage medium and an internal memory. The non-volatile storage medium stores an operating system and a computer program. The internal memory provides an environment for running of the operating system and the computer program in the non-volatile storage medium. The input/output interface of the computer device is configured to exchange information between the processor and an external device. The communication interface of the computer device is configured to perform wired or wireless communication with an external terminal. The wireless communication may be realized through WIFI, a mobile cellular network, near-field communication (NFC), or other technologies. The computer program, when executed by the processor, implements a tunnel scene recognition method. The display unit of the computer device is configured to form a visually visible image, and may be a display screen, a projection apparatus, or a virtual reality imaging apparatus. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, a touchpad, a mouse, or the like.

For a person skilled in the art, a structure shown in FIG. 15 is merely a block diagram of part of a structure related to a solution of this application, and does not constitute a limitation to the computer device to which the solution of this application is applied. Specific computer devices may include components than those shown in the figure, or some components may be combined, or different component arrangements are provided.

In an embodiment, a computer device is further provided, which includes a memory and a processor. The memory has a computer program stored therein, and the processor, when executing the computer program, causing the computer device to implement the operations of each of the foregoing method embodiments.

In an embodiment, a non-transitory computer-readable storage medium is provided, which has a computer program stored therein. The computer program, when executed by a processor of a computer device, causing the computer device to implement the operations of each of the foregoing method embodiments.

In an embodiment, a computer program product is provided, which includes a computer program. The computer program, when executed by a processor, implements the operations of each of the foregoing method embodiments.

User information (including, but not limited to, user equipment information, personal information of a user, and the like) and data (including, but not limited to, data for analysis, stored data, displayed data, and the like) involved in this application both are information and data that are authorized by a user or fully authorized by all parties. Collection, use, and processing of related data need to comply with relevant laws and regulations of relevant countries and regions.

A person of ordinary skill in the art may understand that all or some of procedures of the method in the foregoing embodiments may be implemented by a computer program instructing relevant hardware. The computer program may be stored in a non-volatile computer-readable storage medium. When the computer program is executed, the procedures of the foregoing method embodiments may be included. Any reference to a memory, a database, or other media used in the embodiments provided by this application may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache memory. For illustration rather than limitation, the RAM may be in various forms, such as a static random access memory (SRAM), or a dynamic random access memory (DRAM). The database involved in the embodiments provided in this application may include at least one of a relational database and a non-relational database. The non-relational database may include a distributed database based on a block chain, and is not limited thereto. The processor involved in the embodiments provided in this application may be a general purpose processor, a central processing unit, a graphic processing unit, a digital signal processor, a programmable logic unit, a data processing logic unit based on quantum computing, and the like, and is not limited thereto.

Technical features of the foregoing embodiments may be randomly combined. To make description concise, not all combinations of the technical features in the foregoing embodiments are described. However, the combinations of these technical features shall be considered as falling within the scope recorded by this specification provided that no conflict exists.

The foregoing embodiments only describe several implementations of this application, which are described specifically and in detail, but cannot be construed as a limitation to the patent scope of the present disclosure. For a person of ordinary skill in the art, several transformations and improvements may be made without departing from the idea of this application. These transformations and improvements belong to the protection scope of this application. Therefore, the protection scope of the patent of this application shall be subject to the appended claims.

What is claimed is:

1. A tunnel scene recognition method performed by a computer device the method comprising:
acquiring point cloud data corresponding to a position of a motion path of a vehicle;
segmenting the point cloud data into a plurality of point cloud subsets along different spatial positions on the motion path;
for each point cloud subset, determining a ray cluster including a plurality of rays emitting from a ray origin on the vehicle to corresponding spatial points in the point cloud subset and a center point of the ray cluster based on positions of the spatial points in the ray cluster;
determining closed-distribution characteristics of the spatial points in each point cloud subset based on first distances between the spatial points in the ray cluster and the ray origin and continuous-distribution characteristics of the spatial points in the point cloud subset based on a second distance between the center point of the ray cluster and the ray origin; and
recognizing a motion sub-path in a tunnel scene in the motion path based on the closed-distribution characteristics and the continuous-distribution characteristics of respective spatial points in the plurality of point cloud subsets.

2. The method according to claim 1, wherein the acquiring point cloud data corresponding to a position of a motion path of a vehicle comprises:
extracting, from a point cloud data set corresponding to the spatial positions of the motion path of the vehicle, at least two frames of original point cloud data corresponding to different sampling path points in the motion path;
performing registration stitching on the at least two frames of original point cloud data to obtain stitched point cloud data; and
selecting point cloud data meeting a height condition from the stitched point cloud data.

3. The method according to claim 1, wherein the segmenting the point cloud data into a plurality of point cloud subsets along different spatial positions on the motion path comprises:
determining a segmentation plane, a point cloud subset size, and a point cloud subset interval of the point cloud data;
determining a point cloud subset coordinate condition based on the segmentation plane, the point cloud subset size, and the point cloud subset interval; and
dividing spatial points, in the point cloud data, meeting the same point cloud subset coordinate condition into the same point cloud subset to obtain a preset quantity of point cloud subsets.

4. The method according to claim 3, wherein the determining a segmentation plane, a point cloud subset size, and a point cloud subset interval of the point cloud data comprises:
acquiring scanning parameters of a multi-beam laser radar configured to collect the point cloud data;
determining the segmentation plane based on the central scanning beam direction and the scanning direction;
determining the point cloud subset size based on the number of laser beams and the field-of-view angle; and
determining the point cloud subset interval based on the vehicle traveling speed and the scanning frequency.

5. The method according to claim 1, wherein the determining a ray cluster including a plurality of rays emitting from a ray origin on the vehicle to corresponding spatial points in the point cloud subset comprises:
determining a reference coordinate axis using the ray origin in the point cloud subset;
emitting a ray to a respective spatial point in the point cloud subset from the ray origin;
determining an included angle between the ray and the reference coordinate axis; and
when an angle difference between the included angle and a target ray cluster angle value is less than an angle difference threshold, adding the ray corresponding to the included angle to the ray cluster corresponding to the target ray cluster angle value.

6. The method according to claim 1, wherein the determining closed-distribution characteristics of the spatial points in each point cloud subset based on first distances between the spatial point in the ray cluster and the ray origin comprises:
when a difference value between a maximum value and a minimum value of the first distances is less than a first distance difference, determining the ray cluster to be a candidate ray cluster; and
determining the closed-distribution characteristics of the spatial points in the point cloud data based on a proportion of the candidate ray clusters in the ray clusters of the point cloud data.

7. The method according to claim 1, wherein the determining continuous-distribution characteristics of the spatial points in the point cloud subset based on a second distance between the center point of the ray cluster and the ray origin comprises:
when a difference value between the second distance of the ray cluster and the second distance of an adjacent ray cluster is less than a second distance difference, determining the ray cluster to be a normal ray cluster; and
determining the continuous-distribution characteristics of the spatial points in the point cloud data based on a proportion of normal ray clusters in the ray clusters of the point cloud data.

8. The method according to claim 1, wherein the recognizing a motion sub-path in a tunnel scene in the motion path based on the closed-distribution characteristics and the continuous-distribution characteristics of respective spatial points in the plurality of point cloud subsets comprises:
determining a scene type of the sampling path points based on the closed-distribution characteristics and the continuous-distribution characteristics of spatial points in the point cloud subsets; and
determining a motion sub-path whose scene type is a tunnel scene type and to which at least two continuous sampling path points belong in the motion path as the motion sub-path in the tunnel scene.

9. The method according to claim 8, wherein the determining a scene type of the sampling path points based on the closed-distribution characteristics and the continuous-distribution characteristics of spatial points in the point cloud subsets comprises:
when the closed-distribution characteristics of the spatial points in the point cloud subset indicate that the point cloud subset is in a closed state, and the continuous-distribution characteristics indicate that the point cloud subset is continuous, determining the point cloud subset to be a candidate tunnel point cloud subset; and
when a proportion of the candidate tunnel point cloud subsets in the point cloud subsets corresponding to the sampling path point reaches a proportion threshold, determining the scene type corresponding to the sampling path points to be the tunnel scene type.

10. The method according to claim 1, comprising:
when a motion sub-path corresponding to target point cloud data is the motion sub-path in the tunnel scene, registering the target point cloud data with a point cloud map.

11. A computer device, comprising a memory and a processor, the memory having a computer program stored therein, and the processor, when executing the computer program, causing the computer device to implement a tunnel scene recognition method including:
acquiring point cloud data corresponding to a position of a motion path of a vehicle;
segmenting the point cloud data into a plurality of point cloud subsets along different spatial positions on the motion path;
for each point cloud subset, determining a ray cluster including a plurality of rays emitting from a ray origin on the vehicle to corresponding spatial points in the point cloud subset and a center point of the ray cluster based on positions of the spatial points in the ray cluster;
determining closed-distribution characteristics of the spatial points in each point cloud subset based on first distances between the spatial points in the ray cluster and the ray origin and continuous-distribution characteristics of the spatial points in the point cloud subset based on a second distance between the center point of the ray cluster and the ray origin; and
recognizing a motion sub-path in a tunnel scene in the motion path based on the closed-distribution characteristics and the continuous-distribution characteristics of respective spatial points in the plurality of point cloud subsets.

12. The computer device according to claim 11, wherein the acquiring point cloud data corresponding to a position of a motion path of a vehicle comprises:
extracting, from a point cloud data set corresponding to the spatial positions of the motion path of the vehicle, at least two frames of original point cloud data corresponding to different sampling path points in the motion path;
performing registration stitching on the at least two frames of original point cloud data to obtain stitched point cloud data; and
selecting point cloud data meeting a height condition from the stitched point cloud data.

13. The computer device according to claim 11, wherein the segmenting the point cloud data into a plurality of point cloud subsets along different spatial positions on the motion path comprises:
determining a segmentation plane, a point cloud subset size, and a point cloud subset interval of the point cloud data;
determining a point cloud subset coordinate condition based on the segmentation plane, the point cloud subset size, and the point cloud subset interval; and
dividing spatial points, in the point cloud data, meeting the same point cloud subset coordinate condition into the same point cloud subset to obtain a preset quantity of point cloud subsets.

14. The computer device according to claim 13, wherein the determining a segmentation plane, a point cloud subset size, and a point cloud subset interval of the point cloud data comprises:
acquiring scanning parameters of a multi-beam laser radar configured to collect the point cloud data;
determining the segmentation plane based on the central scanning beam direction and the scanning direction;
determining the point cloud subset size based on the number of laser beams and the field-of-view angle; and
determining the point cloud subset interval based on the vehicle traveling speed and the scanning frequency.

15. The computer device according to claim 11, wherein the determining a ray cluster including a plurality of rays emitting from a ray origin on the vehicle to corresponding spatial points in the point cloud subset comprises:
determining a reference coordinate axis using the ray origin in the point cloud subset;
emitting a ray to a respective spatial point in the point cloud subset from the ray origin;
determining an included angle between the ray and the reference coordinate axis; and
when an angle difference between the included angle and a target ray cluster angle value is less than an angle difference threshold, adding the ray corresponding to the included angle to the ray cluster corresponding to the target ray cluster angle value.

16. The computer device according to claim 11, wherein the determining closed-distribution characteristics of the spatial points in each point cloud subset based on first distances between the spatial point in the ray cluster and the ray origin comprises:
when a difference value between a maximum value and a minimum value of the first distances is less than a first distance difference, determining the ray cluster to be a candidate ray cluster; and
determining the closed-distribution characteristics of the spatial points in the point cloud data based on a proportion of the candidate ray clusters in the ray clusters of the point cloud data.

17. The computer device according to claim 11, wherein the determining continuous-distribution characteristics of the spatial points in the point cloud subset based on a second distance between the center point of the ray cluster and the ray origin comprises:
when a difference value between the second distance of the ray cluster and the second distance of an adjacent ray cluster is less than a second distance difference, determining the ray cluster to be a normal ray cluster; and
determining the continuous-distribution characteristics of the spatial points in the point cloud data based on a proportion of normal ray clusters in the ray clusters of the point cloud data.

18. The computer device according to claim 11, wherein the recognizing a motion sub-path in a tunnel scene in the motion path based on the closed-distribution characteristics and the continuous-distribution characteristics of respective spatial points in the plurality of point cloud subsets comprises:
determining a scene type of the sampling path points based on the closed-distribution characteristics and the continuous-distribution characteristics of spatial points in the point cloud subsets; and
determining a motion sub-path whose scene type is a tunnel scene type and to which at least two continuous sampling path points belong in the motion path as the motion sub-path in the tunnel scene.

19. The computer device according to claim 18, wherein the determining a scene type of the sampling path points based on the closed-distribution characteristics and the continuous-distribution characteristics of spatial points in the point cloud subsets comprises:
when the closed-distribution characteristics of the spatial points in the point cloud subset indicate that the point cloud subset is in a closed state, and the continuous-distribution characteristics indicate that the point cloud subset is continuous, determining the point cloud subset to be a candidate tunnel point cloud subset; and
when a proportion of the candidate tunnel point cloud subsets in the point cloud subsets corresponding to the sampling path point reaches a proportion threshold, determining the scene type corresponding to the sampling path points to be the tunnel scene type.

20. A non-transitory computer-readable storage medium, having a computer program stored therein, the computer program, when executed by a processor of a computer device, causing the computer device to implement a tunnel scene recognition method including:
acquiring point cloud data corresponding to a position of a motion path of a vehicle;
segmenting the point cloud data into a plurality of point cloud subsets along different spatial positions on the motion path;
for each point cloud subset, determining a ray cluster including a plurality of rays emitting from a ray origin on the vehicle to corresponding spatial points in the point cloud subset and a center point of the ray cluster based on positions of the spatial points in the ray cluster;
determining closed-distribution characteristics of the spatial points in each point cloud subset based on first distances between the spatial points in the ray cluster and the ray origin and continuous-distribution characteristics of the spatial points in the point cloud subset based on a second distance between the center point of the ray cluster and the ray origin; and
recognizing a motion sub-path in a tunnel scene in the motion path based on the closed-distribution characteristics and the continuous-distribution characteristics of respective spatial points in the plurality of point cloud subsets.
